(19) United States
(12) Patent Application Publication
(10) Pub. No.: US 2024/0413357 A1
(43) Pub. Date: Dec. 12, 2024

(54) ELECTROCHEMICAL CELL FRAME ASSEMBLIES WITH ANTI-BULGE FEATURES

(71) Applicant: Twelve Benefit Corporation, Berkeley, CA (US)

(72) Inventors: Adel B. Jilani, North Vancouver (CA); Simon Gregory Stone, Arlington, MA (US); Gaurav Kalyan Shetti, Oakland, CA (US)

(21) Appl. No.: 18/736,368

(22) Filed: Jun. 6, 2024

Related U.S. Application Data
(60) Provisional application No. 63/507,063, filed on Jun. 8, 2023.

(51) Int. Cl. H01M 8/0273; C25B 9/60; H01M 8/0206; H01M 8/0258

(52) U.S. Cl. CPC H01M 8/0273; C25B 9/60; H01M 8/0206; H01M 8/0258

(57) ABSTRACT

Frame assemblies for use in locating and positioning flow fields in an electrochemical cell stack are provided. The frame assemblies may have a separator plate that is interposed between two frames. The separator plate may have one or more raised features positioned around or on either side of flow field regions of the separator plate that are defined by flow field apertures through the frames. The one or more raised features may extend into corresponding receiving features in one or both frames. The raised feature(s) may thus couple the frames to the separator plate and stiffen the frame assembly so as to prevent or reduce potential flexure of the frames due to pressures that develop within the flow field apertures. Various approaches are disclosed.

### RELATED APPLICATION(S)

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Fuel cells and electrolyzers both typically include a plurality of cells that each utilize a component referred to as a “membrane electrode assembly” (MEA). An MEA typically includes a polymer electrolyte membrane (PEM) that has one or more layers of material applied to one or both sides. The MEA is typically sandwiched between two flow fields that are configured to distribute fluids across the MEA during use. The present disclosure is directed at improvements to structures that are used to position and retain such flow fields in place relative to an MEA.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Details of one or more implementations of the subject matter described in this specification are set forth in the accompanying drawings and the description below. Other features, aspects, and advantages will become apparent from the description, the drawings, and the claims.

In some implementations, a cell frame assembly for an electrochemical cell may be provided. The cell frame assembly may include a separator plate having a first side and a second side, the first side of the separator plate facing in an opposite direction from the second side of the separator plate. The cell frame assembly may also include a first frame having a first side, a second side, an inner perimeter, and an outer perimeter. The first side of the first frame may face towards the first side of the separator plate and the second side of the first frame may face in an opposite direction from the first side of the first frame. The inner perimeter of the first frame may define a first flow field aperture that defines a first flow field region on the first side of the separator plate. The separator plate may be positioned adjacent to the first frame and may span across the first flow field aperture, the first side of the separator plate may include one or more first raised features, each first raised feature may have a corresponding first surface that is closer to the second side of the first frame than a corresponding portion of the first side of the separator plate adjacent to that first raised feature and outside of the first flow field region, the first side of the first frame may include one or more first receiving features, each first receiving feature may be sized to receive at least one of the one or more first raised features, and each first receiving feature may be configured to constrain translation of the first frame relative to the separator plate in at least one direction transverse to the cell frame assembly when the at least one of the one or more first raised features extends into that first receiving feature.

In some implementations, each first raised feature may be a portion of the separator plate having an increased thickness relative to other portions of the separator plate.

In some such implementations, the separator plate may be a single, unitary piece.

In some implementations, the separator plate may include a sheet of material and each first raised feature may be provided by a first wall element that is affixed to the sheet of material.

In some such implementations, the sheet of material and the one or more first wall elements may be made of metal and the one or more first wall elements may be welded, soldered, or brazed to the sheet of material.

In some implementations, the sheet of material and the one or more first wall elements may be made of metal and the one or more first wall elements may be deposited on the sheet of material via additive manufacturing.

In some implementations, the cell frame assembly may further include a second frame having a first side, a second side, an inner perimeter, and an outer perimeter. The first side of the second frame may face towards the second side of the separator plate and the second side of the second frame may face in an opposite direction from the first side of the second frame. The inner perimeter of the second frame may define a second flow field aperture that defines a second flow field region on the second side of the separator plate, the separator plate may be interposed between the first frame and the second frame and may span across the second flow field aperture, the second side of the separator plate may include one or more second raised features, each second raised feature may have a corresponding second surface that is closer to the second side of the second frame than a corresponding portion of the second side of the separator plate adjacent to that second raised feature and outside of the second flow field region, the first side of the second frame may include one or more second receiving features, each second receiving feature may be sized to receive at least one of the one or more second raised features, each second receiving feature may be configured to constrain translation of the second frame relative to the separator plate in at least one direction transverse to the cell frame assembly when the at least one of the one or more second raised features extends into that second receiving feature, and each second raised feature may be a portion of the separator plate having an increased thickness relative to other portions of the separator plate.

In some such implementations, the separator plate may be a single, unitary piece.

In some implementations, the separator plate may include a sheet of material, each first raised feature may be provided by a first wall element that is affixed to a first side of the sheet of material, and each second raised feature may be provided by a second wall element that is affixed to a second side of the sheet of material opposite the first side of the sheet of material.

In some such implementations, the sheet of material, the one or more first wall elements, and the one or more second wall elements may be made of metal, the one or more first wall elements may be welded, soldered, or brazed to the sheet of material, and the one or more second wall elements may be welded, soldered, or brazed to the sheet of material.

In some implementations, the sheet of material, the one or more first wall elements, and the one or more second wall elements may be made of metal, the one or more first wall elements may be deposited on the sheet of material via additive manufacturing, and the one or more second wall elements may be deposited on the sheet of material via additive manufacturing.

In some implementations, each first raised feature may be located in a corresponding first location on the first side of the separator plate, each second raised feature may be located in a corresponding second location on the second side of the separator plate, and each first location may correspond in location to one of the second locations.

In some implementations, the separator plate may be symmetric about a plane midway between the second sides of the first frame and the second frame.

In some implementations, the separator plate may further include one or more first recessed features, each first recessed feature may correspond in location to one of the first raised features, and the cell frame assembly may further include a second frame having a first side, a second side, an inner perimeter, and an outer perimeter. In such implementations, the first side of the second frame may face towards the second side of the separator plate and the second side of the second frame may face in an opposite direction from the first side of the second frame, the inner perimeter of the second frame may define a second flow field aperture that defines a second flow field region on the second side of the separator plate, and the separator plate may be interposed between the first frame and the second frame and spans across the second flow field aperture.

In some implementations, the separator plate may be made of sheet metal and the correspondence in location between each first raised feature and one of the first recessed features may be provided by a corresponding embossed feature in the sheet metal.

In some such implementations, at least some of the embossed features may be domed embossed features, each domed embossed feature may provide a corresponding convex domed surface that serves as one of the one or more first raised features and a corresponding concave domed surface that serves as one of the one or more first recessed features, and each first recessed feature that receives the convex domed surface of one of the domed embossed features may have a corresponding concave domed surface.

In some further such implementations, the corresponding convex domed surface of each domed embossed feature may mate against the corresponding concave domed surface of the first receiving feature that receives that domed embossed feature.

In some implementations, the first side of the second frame may include one or more second raised features, and each second raised feature may be sized to be insertable into a corresponding one of the first recessed features and configured to constrain translation of the second frame relative to the separator plate in at least one direction transverse to the cell frame assembly when that second raised feature of the one or more second raised features extends into that second receiving feature.

In some implementations, the first side of the second frame may include one or more second raised features, each second raised feature may be sized to be insertable into a corresponding one of the domed embossed features and configured to constrain translation of the second frame relative to the separator plate in at least one direction transverse to the cell frame assembly when that second raised feature of the one or more second raised features extends into that second receiving feature, and each second raised feature inserted into the concave domed surface of one of the domed embossed features may have a corresponding convex domed surface.

In some such implementations, the corresponding convex domed surface of each domed embossed feature may mate against the corresponding concave domed surface of the first receiving feature that receives that domed embossed feature, and the corresponding concave domed surface of each domed embossed feature may mate against the corresponding convex domed surface of the second raised feature that is inserted into that domed embossed feature.

In some implementations, a first subset of the domed embossed features may be positioned a first distance away from the first flow field region, a second subset of the domed embossed features may be positioned a second distance away from the first flow field region, and the second distance may be greater than the first distance.

In some implementations, the domed embossed features may be arranged along a zig-zag path.

In some implementations, at least some of the domed embossed features may be in the form of spherical domes.

In some implementations, at least some of the domed embossed features may be in the form of obround domes.

In some implementations, the first frame may include a first receiving frame and one or more first frame inserts, each first frame insert may be positioned within a corresponding first recess in the first receiving frame, and the first receiving features may be distributed across the one or more first frame inserts.

In some such implementations, the first frame may have only a single first frame insert and the first frame insert may extend around the first flow field aperture.

In some implementations, the first frame may include a first receiving frame and one or more first frame inserts, the second frame may include a second receiving frame and one or more second frame inserts, each first frame insert may be positioned within a corresponding first recess in the first receiving frame, each second frame insert may be positioned within a corresponding second recess in the second receiving frame, the first receiving features may be distributed across the one or more first frame inserts, and the second receiving features may be distributed across the one or more second frame inserts.

In some such implementations, the first frame may have only a single first frame insert and the first frame insert may extend around the first flow field aperture, and the second frame may have only a single second frame insert and the second frame insert may extend around the second flow field aperture.

In some further such implementations, the first receiving frame and the second receiving frame may be identical.

In some implementations, the cell frame assembly may further include a first gasket layer interposed between the first side of the separator plate and the first side of the first frame, the first gasket layer having an inner perimeter that defines a first aperture that extends through the first gasket layer.

In some such implementations, the first side of the first frame may include one or more first ridge features located within a first clamping region of the first side of the first frame that overlaps with the first gasket layer when viewed along an axis that is perpendicular to the second side of the first frame, and each first ridge feature may protrude into the first gasket layer when the first frame and the separator plate are caused to compress the portion of the first gasket layer located within the first clamping region.

In some further such implementations, each first ridge feature may extend entirely around the first aperture.

In some further such implementations, the one or more first ridge features may be a plurality of concentrically arranged first ridge features.

In some implementations, the first aperture in the first gasket layer may be the same size and shape as the first flow field aperture in the first frame.

In some implementations, a first gasket layer may be interposed between the first side of the separator plate and the first side of the first frame, the first gasket layer having an inner perimeter that defines a first aperture that extends through the first gasket layer, and a second gasket layer may be interposed between the first side of the separator plate and the first side of the second frame, the second gasket layer having an inner perimeter that defines a second aperture that extends through the second gasket layer.

In some implementations, the first side of the first frame may include one or more first ridge features located within a first clamping region of the first side of the first frame that overlaps with the first gasket layer when viewed along an axis that is perpendicular to the second side of the first frame. Each first ridge feature may protrude into the first gasket layer when the first frame and the separator plate are caused to compress the portion of the first gasket layer located within the first clamping region, the first side of the second frame may include one or more second ridge features located within a second clamping region of the first side of the second frame that overlaps with the second gasket layer when viewed along an axis that is perpendicular to the second side of the first frame, and each second ridge feature may protrude into the second gasket layer when the second frame and the separator plate are caused to compress the portion of the second gasket layer located within the second clamping region.

In some implementations, each first ridge feature may extend entirely around the first aperture, and each second ridge feature may extend entirely around the second aperture.

In some such implementations, the one or more first ridge features may be a plurality of concentrically arranged first ridge features, and the one or more second ridge features may be a plurality of concentrically arranged second ridge features.

In some implementations, the first aperture in the first gasket layer may be the same size and shape as the first flow field aperture in the first frame, and the second aperture in the second gasket layer may be the same size and shape as the second flow field aperture in the second frame.

In some implementations, the first gasket layer and the second gasket layer may both be made of a material including polytetrafluoroethylene.

In some implementations, the first gasket layer may be made of a material including polytetrafluoroethylene.

In some implementations, the one or more first raised features may include at least two first raised features that are positioned such that the first flow field aperture is interposed between the at least two first raised features.

In some implementations, the one or more first raised features may include at least one first wall element that extends entirely around the first flow field aperture.

In some such implementations, there may be only one first raised feature and the first raised feature may extend entirely around the first flow field aperture.

In some implementations, the one or more first raised features may include a plurality of first raised features distributed throughout a region that encircles the first flow field region.

In some implementations, the one or more first raised features may include a plurality of first raised features distributed throughout a first region on one side of the first flow field region and a second region on an opposite side of the first flow field region.

In some implementations, the separator plate may be made of metal.

In some further such implementations, the separator plate may be made of a titanium-containing metal.

In some implementations, the first frame may be made of a polymeric material.

It will be appreciated that the above implementations are just some of the potential implementations that will be apparent from the Figures and discussion thereof provided herein, and that other implementations that are also apparent from the Figures and discussion are also considered within the scope of this disclosure.

### BRIEF DESCRIPTION OF THE DRAWINGS

Various embodiments disclosed herein are illustrated by way of example, and not by way of limitation, in the figures of the accompanying drawings, in which like reference numerals refer to similar elements.

FIG. 1 depicts an example frame assembly that provides further context to the above discussion.

FIG. 2 depicts the example frame assembly of FIG. 1 in an exploded view.

FIG. 3 depicts a plan view of the example frame assembly of FIGS. 1 and 2 indicating an implementation in which first raised features extend entirely around a flow field aperture.

FIG. 4 depicts a plan view of the example frame assembly of FIGS. 1 and 2 indicating an implementation in which first raised features extend only partially around a flow field aperture.

FIG. 5 depicts a cross-sectional view of an example frame assembly with flow fields installed.

FIG. 6 depicts an exploded cross-sectional view of the example frame assembly of FIG. 5.

FIG. 7 depicts an exploded partial section view of an example frame assembly.

FIG. 8 depicts the example frame assembly of FIG. 7 in an assembled state.

FIG. 9 depicts a partial cross-sectional view of another example frame assembly.

FIG. 10 depicts a partial cross-sectional view of yet another example frame assembly.

FIG. 11 depicts a partial cross-sectional view of an additional example frame assembly.

FIG. 12 depicts a partial cross-sectional view of another example frame assembly.

FIG. 13 depicts a partial cross-sectional view of a further example frame assembly.

FIG. 14 depicts a partial cross-sectional exploded view of another example frame assembly.

FIG. 15 depicts the example frame assembly of FIG. 14 but in an unexploded, assembled state.

FIG. 16 depicts a partial cross-sectional exploded view of yet another example frame assembly.

FIG. 17 depicts the example frame assembly of FIG. 16 but in an unexploded, assembled state.

FIG. 18 depicts a partial cross-sectional exploded view of another example frame assembly.

FIG. 19 depicts the example frame assembly of FIG. 18 but in an unexploded, assembled state.

FIG. 20 depicts a partial cross-sectional exploded view of another example frame assembly that is a blend of the concept in FIGS. 16 and 17 with the concept in FIGS. 18 and 19.

FIG. 21 depicts the example frame assembly of FIG. 20 but in an unexploded, assembled state.

FIG. 22 depicts an exploded view of a portion of an example frame assembly having domed embossed features for first raised features.

FIG. 23 depicts an exploded view of a portion of another example frame assembly having domed embossed features for first raised features.

FIG. 24 depicts an exploded view of a portion of yet another example frame assembly having domed embossed features for first raised features.

FIGS. 25 and 25′ depict an example frame assembly featuring a multi-piece separator plate.

FIG. 26 depicts another example frame assembly featuring a multi-piece separator plate.

FIG. 27 depicts an example frame assembly featuring a single-piece separator plate with integral flow fields.

FIG. 28 is the same as FIG. 3 but indicating locations for a plurality of raised features.

FIG. 29 is the same as FIG. 4 but indicating locations for a plurality of raised features.

### DETAILED DESCRIPTION OF SOME EMBODIMENTS

Fuel cells and electrolyzer cells both utilize electrochemical cells that are typically arranged in a “stacked” configuration, allowing multiple cells to be supplied with fluids in parallel. It will be understood that while the discussion below focuses on electrolyzer cells, the concepts discussed herein may also be usable in providing fuel cells. Each “cell” in a fuel cell or electrolyzer typically includes an MEA and flow fields placed on opposing sides of the MEA (often with a gas diffusion layer or other similar layers placed in between the flow fields and the MEA). The flow fields are each typically positioned within a corresponding frame that acts to position and retain that flow field in place relative to the MEA. Such frames typically also include fluid supply/return passages that may be used to convey fluids, e.g., gases or liquids, to or from the flow fields. Such frames also act as pressure vessels that maintain a desired pressure environment for the MEAs located therein.

In some instances, a cell frame assembly, or simply “frame assembly,” may be provided that includes two frames that are configured to locate and position flow fields for two adjacent cells. For example, one frame and flow field for a given cell may be designed for use on the cathode side of the MEA, while another frame and flow field for that cell may be designed for use on the anode side of the MEA. When two or more such cells are stacked together, the anode-side frame and flow field for one cell will generally be adjacent to the cathode-side frame and flow field for an adjacent cell. To simplify the overall assembly of such a stack of cells, each pair of adjacent anode-side and cathode-side frames may be combined into a frame assembly, allowing them to be installed as a unit.

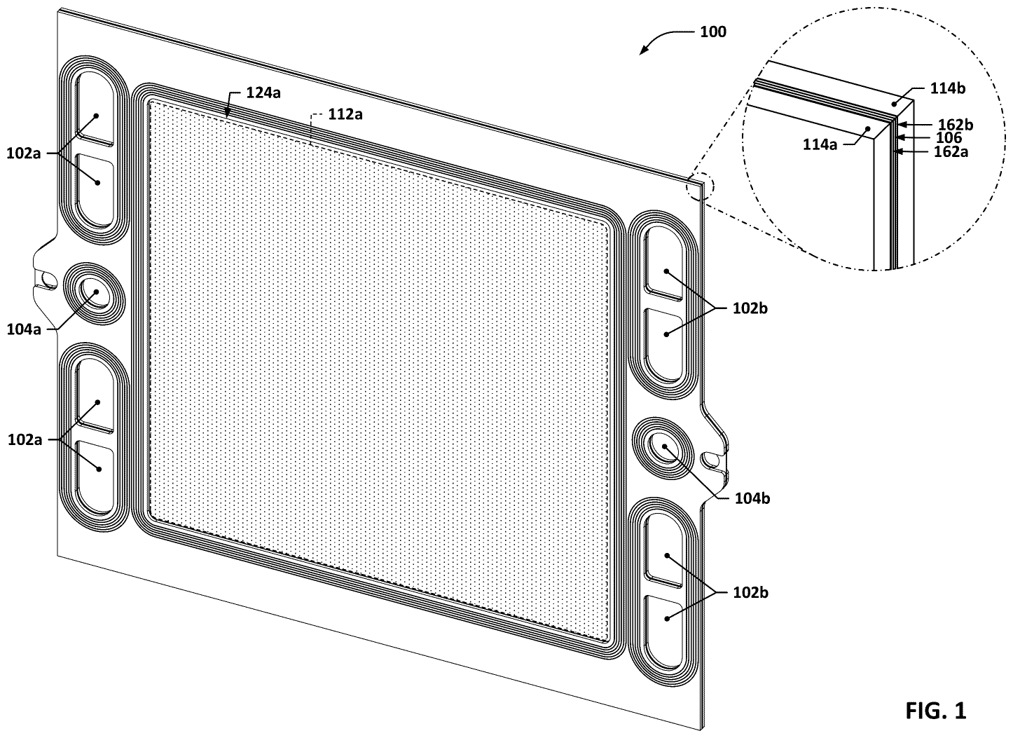

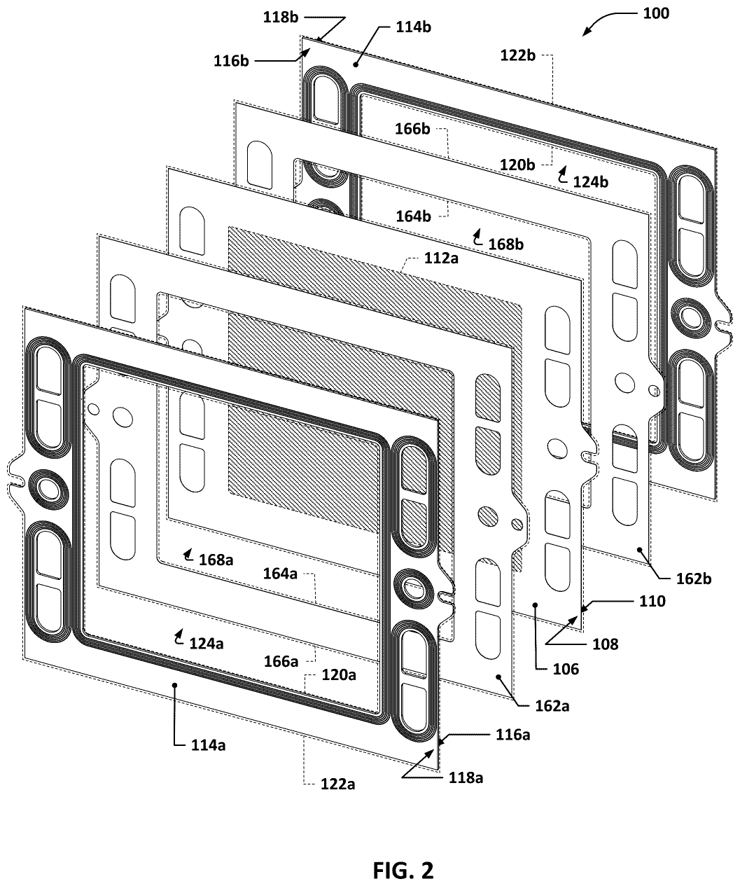

FIG. 1 depicts an example frame assembly 100 that provides further context to the above discussion. FIG. 2 depicts the example frame assembly 100 of FIG. 1 in an exploded view. As can be seen in FIGS. 1 and 2, the frame assembly 100 is a stacked assembly of several layers. In this example, a first frame 114a and a second frame 114b are positioned on either side of a separator plate 106. The interface between the separator plate 106 and the first frame 114a may optionally be sealed with a first gasket layer 162a that may be interposed between the first frame 114a and the separator plate 106. Similarly, the interface between the second frame 114b and the separator plate 106 may be optionally sealed with a second gasket layer 162b that may be interposed between the second frame 114b and the separator plate 106.

The first frame 114a may have an inner perimeter 120a and an outer perimeter 122a. The inner perimeter 120a may, for example, define a first flow field aperture 124a that extends through the first frame 114a. The first flow field aperture 124a may be sized so as to receive a corresponding flow field (not shown), e.g., a plate having a plurality of flow channels or flow paths in the side facing away from the separator plate 106. In this example, the first flow field aperture 124a is a rectangular or square opening through the first frame 114a, although for frame assemblies for MEAs having a circular aspect, the first flow field aperture 124a may be a circular opening through the first frame 114a (generally speaking, the shape of the first flow field aperture 124a may be approximately the same shape and size as the active area of the MEA with which the frame assembly having the first flow field aperture 124a is designed to be used).

Similarly, the second frame 114b may have an inner perimeter 120b and an outer perimeter 122b. The inner perimeter 120b may, for example, define a second flow field aperture 124b that extends through the second frame 114b. The second flow field aperture 124b, similar to the first flow field aperture 124a, may be sized so as to receive a corresponding flow field (not shown). In most cases, the first flow field aperture 124a and the second flow field aperture 124b may be similarly shaped and sized and may be positioned in the same locations on opposite sides of the frame assembly 100, e.g., the first flow field aperture 124a and the second flow field aperture 124b may be mirror images of each other about the separator plate 106.

The first flow field aperture 124a and the second flow field aperture 124b may respectively define a first flow field region 112a and a second flow field region (not shown, but similarly defined as the first flow field region 112a but on the opposite side of the separator plate) on a first side 108 and a second side 110 of the separator plate 106. The first flow field region 112a is depicted as a cross-hatched region in FIG. 2, but it will be understood that the first flow field region 112a may not be visually distinguishable from the remainder of the separator plate 106 without the boundaries defined by the inner perimeter 120a of the first frame 114a. The second flow field region, it will be understood, may similarly have boundaries defined by the inner perimeter 120b of the second frame 114b. The separator plate 106 may thus provide a fluid-impermeable barrier between the first flow field region 112a and the second flow field region, thereby preventing fluid flowed through the first flow field region 112a from flowing into the second flow field region (or vice versa).

The first frame 114a may have a first side 116a that faces towards the separator plate 106 and a second side 118a that faces in an opposite direction from the first side 116a of the first frame 114a, e.g., away from the separator plate 106. Similarly, the second frame 114b may have a first side 116b that faces towards the separator plate 106 and a second side 118b that faces in an opposite direction from the first side 116b of the second frame 114b, e.g., away from the separator plate 106.

As mentioned earlier, in this example frame assembly 100, a first gasket layer 162a is interposed between the separator plate 106 and the first frame 114a. Similarly, a second gasket layer 162b is interposed between the separator plate 106 and the second frame 114b. The first gasket layer 162a may, similar to the first frame 114a, have an inner perimeter 164a and an outer perimeter 166a. The inner perimeter 164a of the first gasket layer 162a may define a first aperture 168a. Similarly, the second gasket layer 162b may have an inner perimeter 164b and an outer perimeter 166b. The inner perimeter 164b of the second gasket layer 162b may define a second aperture 168b. In many implementations, the first aperture 168a, the second aperture 168b, the first flow field aperture 124a, and the second flow field aperture 124b may all be the same size and shape and positioned so as to line up with one another through the stack thickness of the frame assembly 100. In other implementations, the first aperture 168a and/or the second aperture 168b may be differently sized from the first flow field aperture 124a and the second flow field aperture 124b, e.g., sized somewhat larger than the first flow field aperture 124a, and the second flow field aperture 124b.

The frame assembly 100, as discussed earlier, is designed to be stacked with other frame assemblies 100 (with first flow fields and second flow fields installed in the respective first flow field apertures 124a and second flow field apertures 124b) with MEAs and other related components, e.g., gas diffusion layers, interposed between each adjacent pair of frame assemblies. Thus, the first frame 114a (and first flow field contained therein) of a given frame assembly 100 may serve as the anode-side frame and flow field for an electrochemical cell that is on the side of the frame assembly that the first side 108 of the separator plate 106 faces, while the second frame 114b (and the second flow field contained therein) of that frame assembly 100 may serve as the cathode-side frame and flow field for the electrochemical cell that is on the side of the frame assembly that the second side 110 of the separator plate 106 faces.

The first frame 114a and the second frame 114b may generally be made of a non-electrically conductive material, e.g., a polymeric material, while the separator plate 106 may be made of an electrically conductive material, e.g., a metal or metal alloy such as titanium. The flow fields that are eventually installed in each frame assembly 100 may be made of a metal or metal alloy such that the flow fields and the separator plate 106 of a frame assembly 100 may form a continuous electrically conductive path through the frame assembly 100. The flow fields may also alternatively be made of an electrically conductive polymeric material, such as a non-conductive polymeric resin that is mixed with an electrically conductive material, such as carbon, nickel, silver, etc., such that a component made of the cured polymeric resin is electrically conductive. The separator plate 106 may thus act as an electrically conductive pathway through the cell stack.

The separator plate 106 also acts to seal each electrochemical cell off from neighboring electrochemical cells, thereby preventing fluids from leaking in between cells via the interfaces between the flow fields and their respective frames (e.g., the first frame 114a and the second frame 114b). The first gasket layer 162a and the second gasket layer 162b may, for example, be made of a compressible material that is suitable for providing a seal in between the separator plate 106 and the first frame 114a and the second frame 114b. For example, the first gasket layer 162a and the second gasket layer 162b may be made of polytetrafluoroethylene (PTFE) or a similar material.

The first frame 114a and/or the second frame 114b may be subjected to various forces during installation and use. For example, the entire stack of frame assemblies for a given electrolyzer may be compressed, e.g., using a plurality of threaded rod connections, to compress the electrochemical cells into a condition that leaves the cell stack in an operable state, e.g., with the first gasket layers 162a and the second gasket layers 162b compressed sufficiently that they provide a fluid-tight seal. At the same time, the frame assemblies 100 may also be subjected to internal pressure, e.g., resulting from pressurization of the fluids flowing through the flow fields contained within the first frames 114a and/or the second frames 114b. In some instances, such internal pressures may push outward on the inner walls of the first frames 114a and/or the second frames 114b. Such internal pressurization may cause the first frames 114a and/or the second frames 114b to bulge outward (if the first flow field aperture 124a and the second flow field aperture 124b are not circular-if circular, then the first frames 114a and/or the second frames 114b may, in some cases, simply expand radially outward.

One solution for preventing such bulging or expansion is to create perforations in the separator plate 106 and then have features that are part of the first frame 114a and/or the second frame 114b be inserted through such perforations, thereby effectively riveting the first frame 114a to the separator plate 106, thereby allowing the separator plate 106 to stiffen the first frame 114a and the second frame 114b. The other of the first frame 114a and/or the second frame 114b in such implementations may have holes that may receive the features that are inserted through the perforations. For example, in some implementations, one of the first frame 114a and the second frame 114b may have threaded metal inserts installed in it while the other of the first frame 114a and the second frame 114b may have through-holes therethrough. The through-holes and threaded inserts may align with through-holes in the separator plate 106. Threaded fasteners may be inserted through the through-holes in one of the first frame 114a and the second frame 114b, through the through-holes in the separator plate 106, and into the threaded metal inserts in the other of the first frame 114a and the second frame 114b. Such an approach may be effective, but may also be relatively expensive due to the hardware required (the threaded fasteners and threaded inserts that would be needed for each such frame assembly). Additionally, such frame assemblies 100 may be difficult to assemble due to the need to install a relatively large number of threaded fasteners, e.g., 20 to 30 or more such fasteners. When one considers that a cell stack may have dozens or even upward of one hundred cell frame assemblies 100, it will be readily apparent that thousands of threaded fasteners may need to be installed in the frame assemblies 100 for just a single stack. Is it useful to mention here the risk of corrosion of threaded fasteners if they are made of stainless steel

Another option that may be used to provide such a solution is to have at least one of the first frame 114a and the second frame 114b include molded polymeric posts that extend from the first side 116a of the first frame 114a and/or from the first side 116b of the second frame 114b. Such molded polymeric posts are configured to extend through corresponding through-holes in the separator plate 106 and into further corresponding holes in the other of the first frame 114a and/or the second frame 114b. Such an approach may avoid the need for threaded inserts and fasteners but may also be non-ideal, particularly in examples where the posts are made of the same polymeric material as the first frame 114a and/or the second frame 114b. For example, since the separator plate 106 may be relatively thin, such post features may be vulnerable to being plastically deformed, e.g., shorn off, when subjected to loading in directions parallel or transverse to the separator plate 106. In such an instance, the separator plate 106 may act somewhat as a knife that may cut into the posts, allowing the first frame 114a and/or the second frame 114b to expand by an amount that corresponds to the depth of the cut made into the posts. Eventually, the damage to the posts may become so severe that the posts may simply shear off from the first frame 114a and/or the second frame 114b when pressurized.

To address such potential issues, the frame assemblies discussed herein may include separator plates 106 that have raised features on at least one of the first sides 108 and the second sides 110 of the separator plates 106. Such raised features may interface with receiving features on one or both of the first frames 114a and the second frames 114b.

Since the raised features are part of the separator plates 106 and are metal, they are much stronger in shear than equivalently sized polymeric features would be in the first frames 114a and/or the second frames 114b. Moreover, the receiving features in the first frames 114a and/or the second frames 114b may generally be larger in cross-sectional area than the raised features (since they extend around the raised features) and may thus have a larger cross-sectional area available to absorb any shear forces that may develop as compared with the polymeric features discussed earlier, e.g., posts.

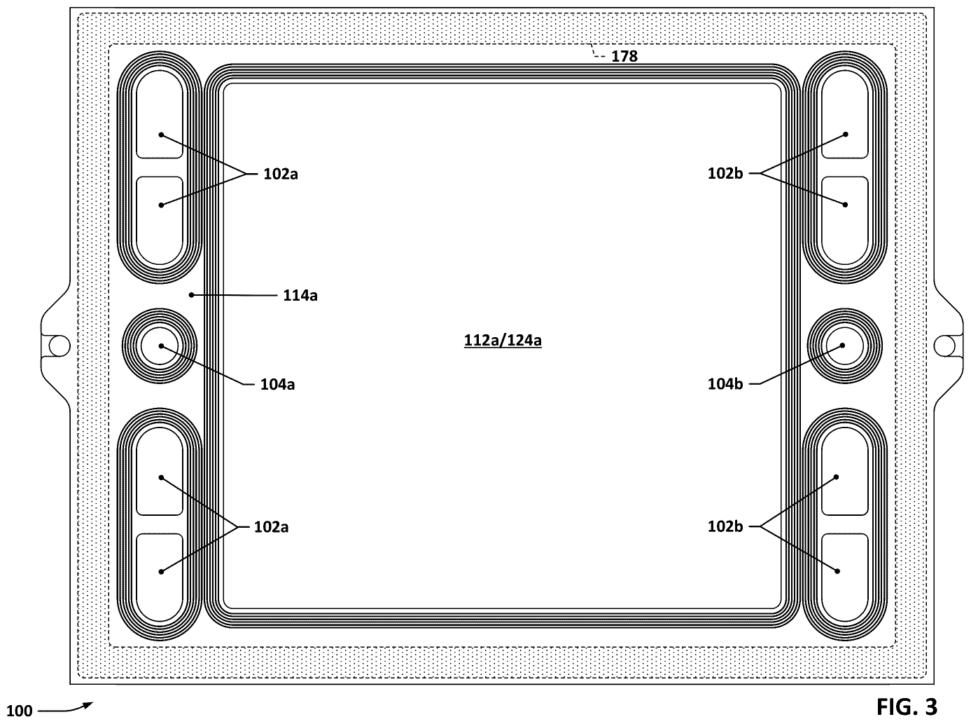

The raised features on the separator plates 106 may be arranged in a variety of ways. In some implementations, a separator plate may have one or more raised features that are disposed about the entire periphery of the separator plate, e.g., completely encircling or extending around the first flow field region 112a, the anode inlets 102a, the anode outlets 102b, the cathode inlets 104a, and/or the cathode outlets 104b. FIG. 3 depicts a plan view of the example frame assembly 100 of FIGS. 1 and 2 indicating such an implementation. For example, the separator plate 106 may have one or more raised features distributed throughout a region 178 that extends around the first flow field region 112a and second flow field region (defined by the first flow field aperture 124a and the second flow field aperture 124b), as well as around the anode inlets 102a, the anode outlets 102b, the cathode inlets 104a, and the cathode outlets 104b. In some such implementations, at least one of the one or more raised features may be a continuous raised feature, e.g., a wall element that protrudes from the bulk of the separator plate 106 and that extends around the first flow field region 112a, the second flow field region, the anode inlets 102a, the anode outlets 102b, the cathode inlets 104a, and the cathode outlets 104b in an unbroken fashion. In other such implementations, there may be multiple such raised features in the region 178, e.g., discrete raised features may be positioned at spaced-apart locations throughout the region 178.

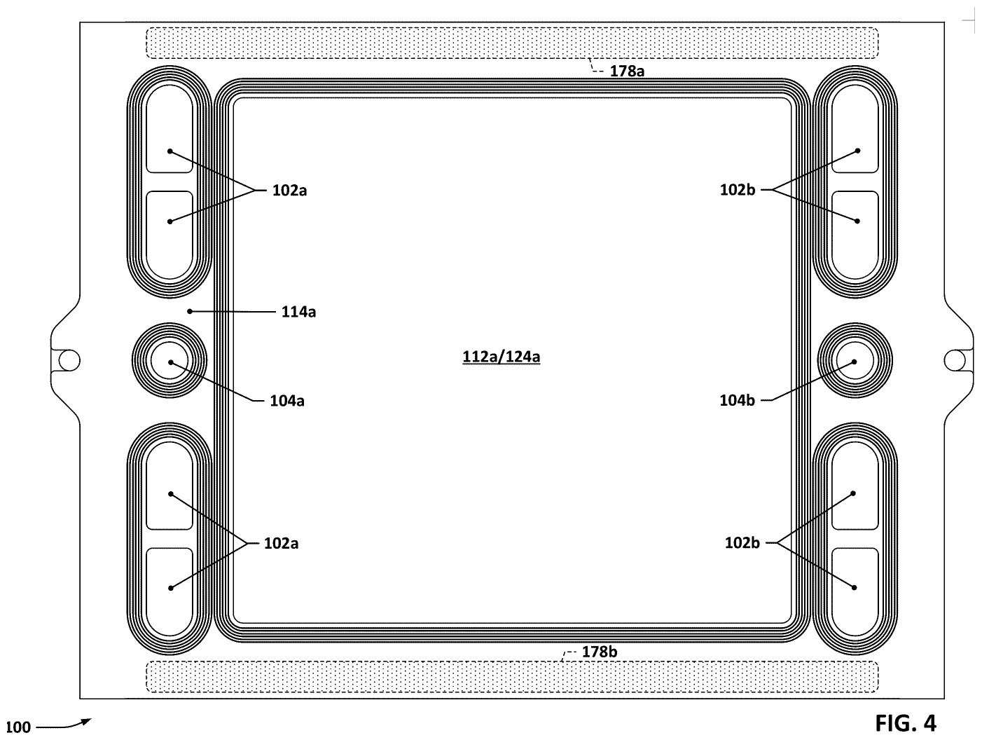

In some other implementations, a separator plate may have a plurality of raised features that are disposed in separate regions about the periphery of the first flow field region 112a and the second flow field region, i.e., so as to not appear to extend around the first flow field region 112a and the second flow field region. FIG. 4 depicts a plan view of the example frame assembly 100 of FIGS. 1 and 2 indicating such an implementation. As can be seen, two separate regions 178a and 178b are shown in FIG. 4. The regions 178a and 178b are positioned such that the first flow field region 112a and the second flow field region (and thus the first flow field aperture 124a and the second flow field aperture 124b) are interposed between the regions 178a and 178b. In such an arrangement, there would be raised features located within each of the regions 178a and 178b, but such raised features may be omitted along other portions of the separator plate extending around the first flow field region 112a, the second flow field region, the anode inlets 102a, the anode outlets 102b, the cathode inlets 104a, and the cathode outlets 104b.

Such an arrangement may, for example, be used when potential bulging of the first frames 114a and the second frames 114b of a particular design of frame assemblies may be more likely to occur in some sections of the first frames 114a and the second frames 114b than in others. For example, for the frame assembly 100, the first frame 114a and the second frame 114b generally have two sets of opposing sides. The two opposing shorter sides that include the anode inlets 102a, the anode outlets 102b, the cathode inlets 104a, and the cathode outlets 104b are generally wider in width (with the width being evaluated along the centerline of the frame assembly passing through the cathode inlet 104a and the cathode outlet 104b) than the two opposing longer sides that are orthogonal to, and span between, the sides including the anode inlets 102a, the anode outlets 102b, the cathode inlets 104a, and the cathode outlets 104b. In such a configuration, the longer, narrower sides will be more flexible than the shorter, wider sides, resulting in more deflection in the longer sides than the short sides when the interior region of the frame assembly is pressurized. In some such implementations, the amount of deflection or flexure in the shorter sides may be within an acceptable tolerance level and there may thus be no need to utilize raised features to prevent the shorter sides from undesirably bulging, while the amount of deflection in the longer sides may be outside of the acceptable tolerance level. Strategically locating raised features along those long sides in order to couple the long side portions of the first frame 114a and the second frame 114b with the separator plate 106 allows those portions of the first frame 114a and the second frame 114b to be structurally reinforced by the separator plate 106, thereby reducing the amount of flexure that the long sides may experience.

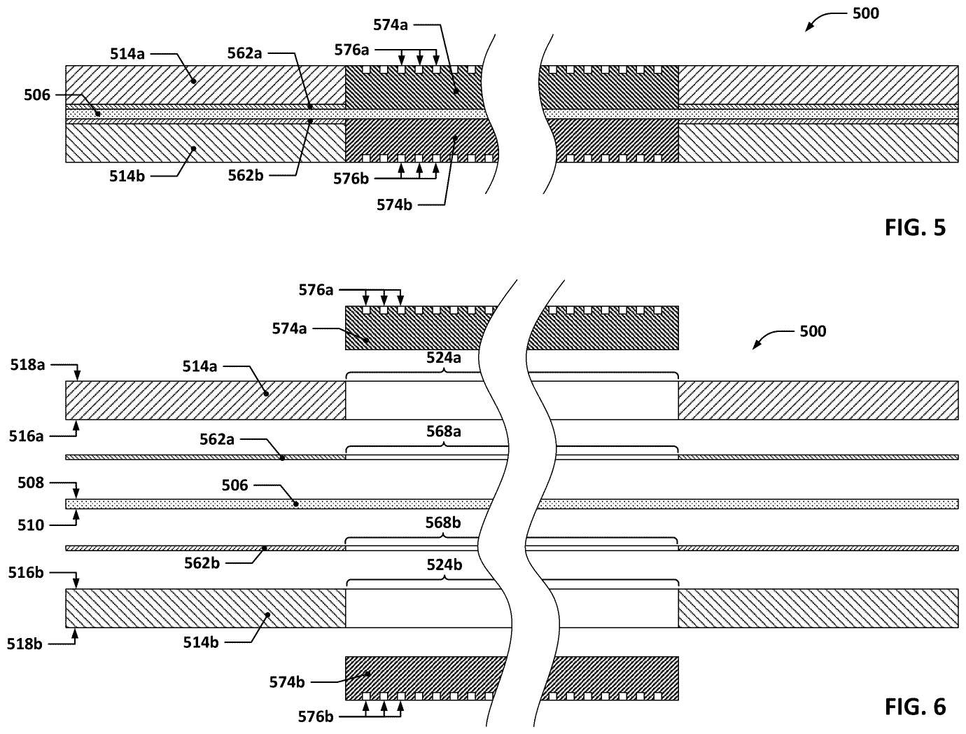

FIG. 5 depicts a cross-sectional view of an example frame assembly with flow fields installed; it will be noted that this example does not include any raised features such as are discussed above but is simply provided as a framework for further discussion below. FIG. 6 depicts an exploded cross-sectional view of the example frame assembly of FIG. 5. As can be seen, a first frame 514a and a second frame 514b are placed on either side of a separator plate 506, with a first side 516a of the first frame 514a facing towards a first side 508 of the separator plate 506 and a second side 518a facing away from the separator plate 506 and a first side 516b of the second frame 514b facing towards a second side 510 of the separator plate 506 and a second side 518b facing away from the separator plate 506.

Also depicted in FIGS. 5 and 6 are a first gasket layer 562a that is interposed between the first frame 514a and the separator plate 506, as well as a second gasket layer 562b that is interposed between the second frame 514b and the separator plate 506. The first gasket layer 562a and the second gasket layer 562b may provide seals between the separator plate 506 and the first frame 514a and the second frame 514b, respectively, when the stack of depicted components is compressed.

As can be seen, the first frame 514a and the first gasket layer 562a respectively have a first flow field aperture 524a and a first aperture 568a that are generally the same size and shape and that are configured to form a pocket or recess, in combination with the separator plate 506, that is sized to receive a first flow field 574a. The first flow field aperture 524a and/or the first aperture 568a may be sized such that there is an interference fit or a press fit between the first flow field 574a and the first flow field aperture 524a and/or the first aperture 568a.

Similarly, the second frame 514b and the second gasket layer 562b respectively have a second flow field aperture 524b and a second aperture 568b that are generally the same size and shape and that are configured to form a pocket or recess, in combination with the separator plate 506, that is sized to receive a second flow field 574b. The second flow field aperture 524b and/or the second aperture 568b may be sized such that there is an interference fit or a press fit between the second flow field 574b and the second flow field aperture 524b and/or the second aperture 568b.

The first flow field 574a and the second flow field 574b may, for example, be generally flat structures that may have a plurality of channels provided in one side, e.g., first flow field channels 576a and second flow field channels 576b, respectively, in the first flow field 574a and the second flow field 574b. In some instances, the first flow field 574a and/or the second flow field 574b may define a large, thin plenum area with a plurality of flow-spreading structures, e.g., posts, pins, mesas, etc., distributed throughout the plenum area. In some implementations, one or both of the first flow field 574a and the second flow field 574b may be provided by way of a stamped sheet metal part. In such cases, the features of the flow field that act to distribute or shape the flow of fluid throughout the corresponding flow field region may be provided by embossed features in the sheet metal part. It will be further understood that different types or geometries of flow fields may be used for the first flow field 574a and the second flow field 574b of a given electrochemical cell in some implementations. For example, whichever of the first flow field 574a and the second flow field 574b is used for the anode-side flow field may have a large plenum area with an array of posts or pins distributed throughout that may act to distribute fluid flowed through the plenum area, while the other of the first flow field 574a and the second flow field 574b that is used for the cathode-side flow field may have a plurality of serpentine channels that act to distribute fluid flowed through that flow field.

In some implementations, the separator plate 506 may be integral with one or both flow fields 574a and 574b. For example, the separator plate 506 may be a stamped sheet metal part that has embossed features that provide the flow-spreading structures stamped directly into the sheet metal that provides the separator plate 506. In some such implementations, the separator plate may be a multi-piece structure, e.g., a first piece of sheet metal that is stamped with embossed features that provide the flow-spreading structures for the first flow field 574a and a second piece of sheet metal that is stamped with embossed features that provide the flow-spreading structures for the second flow field 574b. The first piece of stamped sheet metal and the second piece of stamped sheet metal may then be placed back-to-back, i.e., with the embossed features in each protruding outward in opposite directions to form the separator plate. In some such implementations, first piece of stamped sheet metal and the second piece of stamped sheet metal may be placed back-to-back with a third piece of sheet metal, e.g., a flat piece of sheet metal that is not stamped so as to have the flow-spreading features, interposed between them to provide support to each stamped piece of sheet metal. In such multi-piece separator plates 506, the separate pieces may be optionally bonded together, e.g., using welding, brazing, or other joining techniques. In other implementations, the separate pieces of a multi-piece separator plate may be left as discrete pieces that are not bonded or fused together. It will be appreciated that the various examples discussed herein that feature or depict a single-piece separator plate may also, of course, be implemented in the context of an electrochemical cell that features a multi-piece separator plate.

It will be appreciated that a separator plate—regardless of whether it is a multi-piece or single-piece separator plate—will generally appear to be planar in gross overall shape.

For example, the separator plate will generally be at least one or two orders of magnitude larger in two orthogonal directions, e.g., the x- and y-axis (or two perpendicular horizontal axes) than in a third direction, e.g., the z-axis (or the vertical axis), that is orthogonal to the other two orthogonal directions and parallel to the axis along which electrochemical cells incorporating such separator plates will be stacked when forming an electrochemical cell stack.

The axis along which electrochemical cells incorporating such separator plates are stacked will also be perpendicular to midplanes of the frame assemblies of such electrochemical cells. The midplanes may each be defined so as to be halfway between the second sides of the first frame and the second frame of the corresponding frame assembly for the relevant electrochemical cell. Such midplanes, it will be understood, will generally be parallel to the MEAs of such electrochemical cells and to the second sides of the frame assemblies. Having described various high-level aspects of frame assemblies for electrochemical cells above, the following discussion provides several examples of different types of raised features for the separator plate and various ways of implementing such raised features. The drawings provided for each of these examples focus only on the frame assembly and do not include the flow fields, although it will be understood that such frame assemblies may also include the flow fields that they are designed to position and restrain.

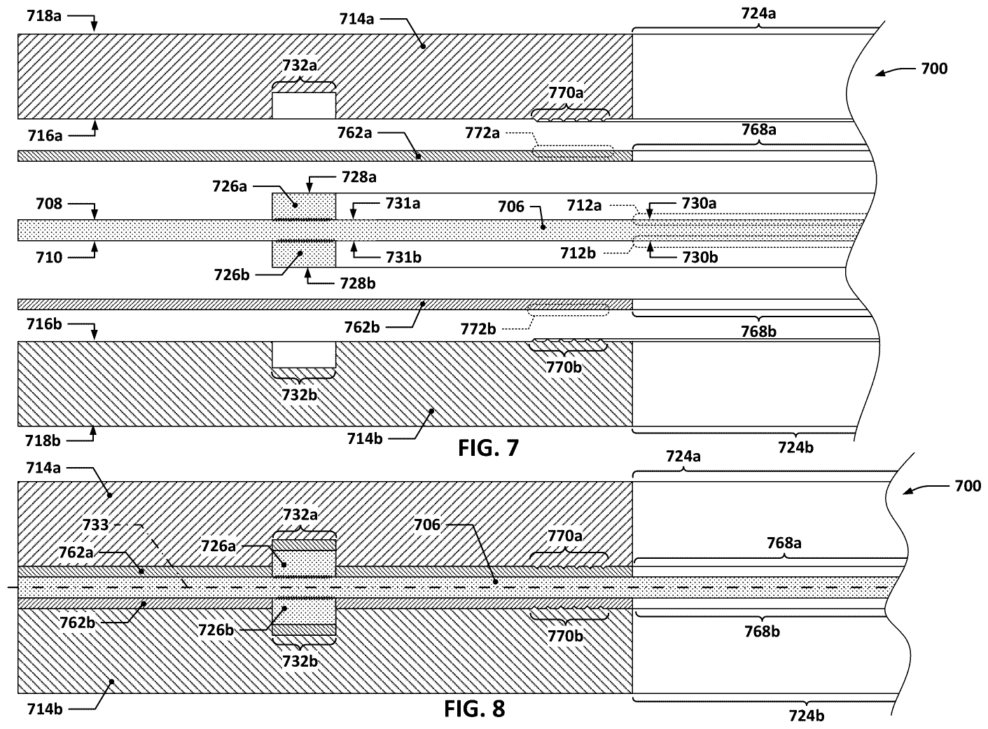

FIG. 7 depicts an exploded partial section view of an example frame assembly 700. FIG. 8 depicts the example frame assembly 700 of FIG. 7 in an assembled state. As can be seen, the frame assembly 700 includes a first frame 714a having a first side 716a that faces towards a first side 708 of a separator plate 706 and a second side 718a that faces in an opposite direction from the first side 716a of the first frame 714a. The frame assembly #700 also includes a second frame 714b having a first side 716b that faces towards a second side 710 of the separator plate 706 and a second side 718b that faces in an opposite direction from the first side 716b of the second frame 714b.

The first frame 714a may have an inner perimeter that defines a first flow field aperture 724a in the first frame 714a which, in turn, may define a first flow field region 712a on the first side 708 of the separator plate 706. Similarly, the second frame 714b may have an inner perimeter that defines a second flow field aperture 724b in the second frame 714b which, in turn, may define a second flow field region 712b on the second side 710 of the separator plate 706. The portion of the first side 708 of the separator plate 706 that lies within the first flow field region 712a may define a first reference plane 730a that is co-planar with that portion of the first side 708 of the separator plate 706. Similarly, the portion of the second side 710 of the separator plate 706 that lies within the second flow field region 712b may define a second reference plane 730b that is co-planar with that portion of the second side 710 of the separator plate 706.

The frame assembly 700 may also include a first gasket layer 762a that is interposed between the first frame 714a and the first side 708 of the separator plate 706, as well as a second gasket layer 762b that is interposed between the second frame 714b and the second side 710 of the separator plate 706. The first gasket layer 762a and the second gasket layer 762b may, for example, be made of PTFE or other suitable compressible material that may be clamped between the separator plate 706 and the first frame 714a and/or the second frame 714b.

In implementations using the first gasket layer 762a, the first frame 714a may, for example, be equipped with one or more first ridge features 770a that each encircle a respective opening through the first frame 714a, e.g., the first flow field aperture 724a or one or more of the anode and cathode inlets and outlets (not shown, but see FIGS. 1-4). In implementations using the second gasket layer 762b, the second frame 714b may, for example, be equipped with one or more second ridge features 770b that each encircle a respective opening through the second frame 714b, e.g., the second flow field aperture 724b or one or more of the anode and cathode inlets and outlets (not shown, but see FIGS. 1-4). In the depicted example, the first ridge features 770a and the second ridge features 770b encircle the first flow field aperture 724a and the second flow field aperture 724b, respectively, but it will be appreciated that additional sets of one or more ridge features may be provided in other locations on the first frame 714a and the second frame 714b so as to encircle other openings through the first frame 714a and the second frame 714b.

The first ridge features 770a may protrude slightly from the first side 716a of the first frame 714a such that when the first frame 714a is pressed against the separator plate 706 with the first gasket layer 762a interposed therebetween, the first ridge features 770a locally deform the first gasket layer 762a in a first clamping region 772a that extends along a path that encircles a first aperture 768a in the first gasket layer 762a that corresponds in shape and size to the first flow field aperture 724a.

In the depicted example, there are six separate first ridge features 770a that are arranged concentrically, resulting in six concentric rings of locally deformed first gasket layer 762a material. These locally deformed portions of the first gasket layer 762a may experience a higher compressive force (and thus compressive pressure) than other regions of the first gasket layer 762a, thereby creating a seal along the locally deformed portions of the first gasket layer 762a.

Similarly, the second ridge features 770b may protrude slightly from the first side 716b of the second frame 714b such that when the second frame 714b is pressed against the separator plate 706 with the second gasket layer 762b interposed therebetween, the second ridge features 770b locally deform the second gasket layer 762b in a second clamping region 772b that extends along a path that encircles a second aperture 768b in the second gasket layer 762b that corresponds in shape and size to the second flow field aperture 724b.

In the depicted example, there are also six separate second ridge features 770b that are arranged concentrically, resulting in six concentric rings of locally deformed second gasket layer 762b material. These locally deformed portions of the second gasket layer 762b, like the locally deformed portions of the first gasket layer 762a, may experience a higher compressive force (and thus compressive pressure) than other regions of the second gasket layer 762b, thereby creating a seal along the locally deformed portions of the second gasket layer 762b.

Also visible in FIGS. 7 and 8 are a first raised feature 726a and a second raised feature 726b. The first raised feature 726a may have a first surface 728a that is closer to the second side 718a of the first frame 714a than a corresponding portion 731a of the first side 708 of the separator plate 706 that is adjacent to the first raised feature 726a and outside of the first flow field region 712a, while the second raised feature 726b may similarly have a second surface 728b that is closer to the second side 718b of the second frame 714b than a corresponding portion 731b of the second side 710 of the separator plate 706 that is adjacent to the second raised feature 726b and outside of the second flow field region 712b. In some cases, the corresponding portions of the first side 708 and/or the second side 710 of the separator plate 706 may be co-planar with, or parallel to, the first reference plane 730a and/or the second reference plane 730b. In the depicted example, the first raised feature 726a is provided by a separate first wall element that, in this example, extends completely around at least the first flow field region 712a. The first wall element, as shown, has a rectangular cross-section and is brazed, welded, soldered, or otherwise attached to a flat sheet of material that forms much of the separator plate 706.

Similarly, the second raised feature 726b is provided by a separate second wall element that, in this example, extends completely around at least the second flow field region 712b. The second wall element, as shown, also has a rectangular cross-section and is also brazed, welded, soldered, or otherwise attached to the flat sheet of material that forms much of the separator plate 706. While the first wall element and the second wall element are shown here as having cross-sectional shapes that are the same size and aspect ratio, it will be understood that other implementations of such separator plates may feature first and second wall elements that have cross-sectional shapes that are different and/or differently sized. It will also be appreciated that the cross-sectional shapes of the first wall element and the second wall element may also be shapes other than rectangular, e.g., trapezoidal, triangular, etc. In this particular example, the first raised feature(s) 726a and the second raised feature(s) 726b are the same size and shape and are positioned in the same locations on opposing sides of the separator plate 706. Thus, the example separator plate 706 is bilaterally symmetric about a midplane 733 of the frame assembly (with the midplane 733 being midway between the second sides 718a and 718b of the first frame 714a and the second frame 714b, respectively).

In some cases, the first and/or second wall elements may be formed on the sheet of material via a deposition process, e.g., such as through additive manufacturing. For example, a flat sheet of material may be placed in an additive manufacturing system, e.g., a direct metal laser sintering system, and may then have one or more layers of material added to it using the additive manufacturing system in order to build up the wall elements layer-by-layer.

The first frame 714a and the second frame 714b may also have a first receiving feature 732a and a second receiving feature 732b, respectively, which may be configured to snugly receive the first raised feature 726a and the second raised feature 726b, respectively. For example, the first receiving feature 732a may be provided by a channel or groove in the first side of the first frame 714a that follows the same path that is followed by the first raised feature 726a. The channel or groove may also have a depth that tracks the height of the first raised feature 726a along its length and a width that generally matches or aligns with the width(s) of the first raised feature 726a in directions perpendicular to the path followed by the first raised feature 726a. Thus, when the first frame 714a is pressed against the separator plate 706, the first raised feature 726a may be inserted into, and received by, the first receiving feature 732a. The first raised feature 726a may thus engage with, and extend into, the first receiving feature 732a and be constrained by the first receiving feature 732a such that the first raised feature 726a presses against the side or sides of the first receiving feature 732a when displaced laterally (in a direction parallel to the midplane 733 of the frame assembly 700 (or transverse to the frame assembly 700) and perpendicular to the path followed by the first raised feature 726a) and is thereby prevented from moving or flexing radially outward more than a small amount (for example, there may be a few thousandths of an inch of clearance between the first raised feature 726a and the first receiving feature 732a that may be provided to account for manufacturing tolerances; in such a case, the first frame 714a and the first raised feature 726a may not be restrained by the first receiving feature 732a until after the first frame 714a and the first raised feature 726a have flexed by a corresponding few thousandths of an inch and come into contact with a sidewall or sidewalls of the first receiving feature 732a. The second raised feature 726b and the second receiving feature 732b may similarly interact, thereby constraining the second frame 714b from flexing or moving relative to the separator plate 706.

It will be understood that while the depicted example frame assembly 700 (and other examples discussed herein) has both a first raised feature 726a and a second raised feature 726b, i.e., raised features 726 on both sides of the separator plate 706, in some implementations, the separator plate 706 may have such raised features on only one side of the separator plate 706, e.g., on the side of the separator plate #706 that is adjacent to the cathode-side flow field. For example, if the anode side and cathode side of an electrochemical cell operates at significantly different operating pressures, there may be a much greater potential for deflection in the frames that are exposed to higher pressures than the frames that are exposed to lower pressures within the electrochemical cell stack. Accordingly, it may be sufficient to provide a raised feature or raised features on the side of the separator plate 706 that is subjected to the higher pressure environment and omit such a raised feature or features on the other side of the separator plate 706.

As can be seen in FIG. 8, when the stacked first frame 714a, first gasket layer 762a, separator plate 106, second gasket layer 762b, and second frame 714b are compressed together, the first raised feature 726a may, when being pushed into the first receiving feature 732a, in some cases, cause the first raised feature 726a and the first receiving feature 732a to act as a punch-and-die that may punch out or partially punch out segments of the first gasket layer 762a that are then trapped between the first surface 728a and the first frame 714a. Similarly, the second raised feature 726b may, when being pushed into the second receiving feature 732b, cause the second raised feature 726b and the second receiving feature 732b, to also act as a punch-and-die set that may punch out or partially punch out segments of the second gasket layer 762b that are then respectively trapped between the second surface 728b and the second frame 714b.

Such an arrangement avoids the need for a large number of discrete fasteners that may significantly increase the component cost and labor cost of providing a frame assembly, and also avoids scenarios in which easily damaged polymeric pin structures may be passed through holes in the separator plate in an attempt to prevent or reduce bulging of the frame assembly.

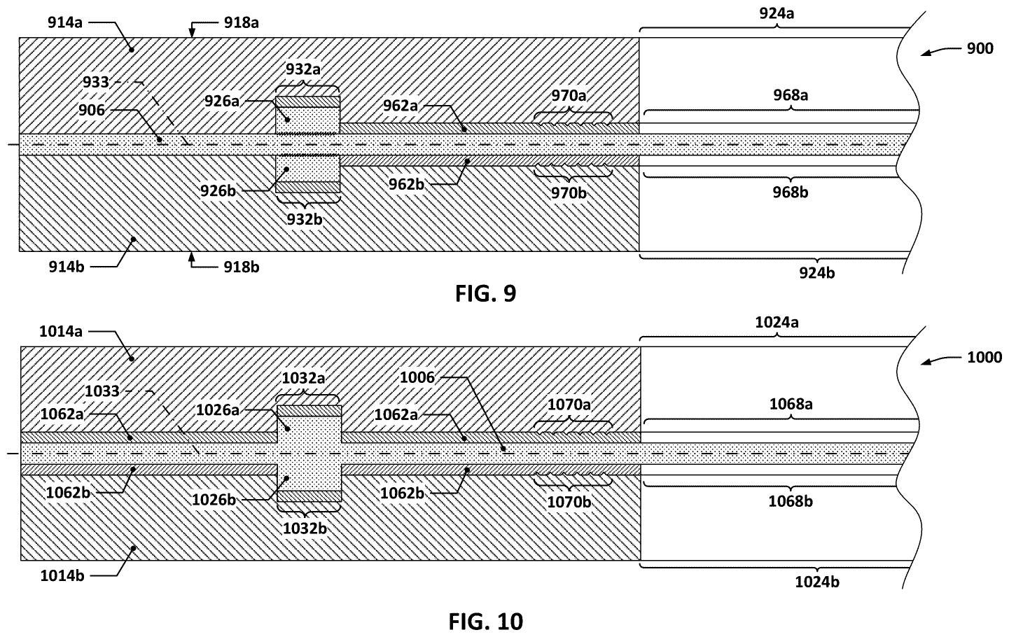

FIG. 9 depicts a partial cross-sectional view of another example frame assembly that is somewhat similar to that of FIGS. 7 and 8. To avoid undue repetition, elements in the implementation of FIG. 9 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIG. 9 unless indicated otherwise. In the interest of conciseness, discussion of these elements that would be redundant of earlier discussion herein of similar elements is not provided, with the understanding that the earlier discussion of such elements is applicable to these similar elements in FIG. 9.

The implementation of FIG. 9 differs from that of FIGS. 7 and 8 in that the first gasket layer 962a and the second gasket layer 962b extend to the first raised feature 926a and the second raised feature 926b but not all the way to the outer perimeters of the first frame 914a and the second frame 914b, respectively. In some such cases, the first gasket layer 962a and/or the second gasket layer 962b may extend to the first raised feature 926a and the second raised feature 926b, but not past the first raised feature 926a and the second raised feature 926b. Regardless, in some such implementations, the portions of the first frame 914a and/or the second frame 914b that do not overlap with a gasket layer (e.g., the first gasket layer 962a or the second gasket layer 962b) may be thicker than the portions of the first frame 914a and/or the second frame 914b that overlap a gasket layer inward of the first raised feature(s) 926a and/or the second raised feature(s) 926b. Put another way, the surfaces of the first frame(s) 914a that do not overlap with the first gasket layer 962a may be offset further by a distance X from the second side 918a of the first frame 914a than the surfaces of the first frame(s) 914a that do overlap with the first gasket layer 962a and that do not form part of the first receiving feature(s) 932a. Similarly, the surfaces of the second frame(s) 914b that do not overlap with the second gasket layer 962b may also be offset further by a distance X from the second side 918b of the second frame 914b than the surfaces of the second frame 914b that do overlap with the second gasket layer 962b and that do not form part of the second receiving feature(s) 932b. The distance X may, for example, be equal to the thickness of the first gasket layer 962a and/or the second gasket layer 962b. Alternatively, the distance X may be set to an expected or desired thickness of the first gasket layer 962a and/or the second gasket layer 962b after the first frame 914a, the first gasket layer 962a, the separator plate 906, the second gasket layer 962b, and the second frame 914b are compressed together, e.g., as they would be in a fully assembled and operational electrochemical cell (in such cases, the distance X would be less than the precompression thickness of the first gasket layer 962a and/or the second gasket layer 962b). Such an implementation may allow for more control of the amount of compression exerted on the first gasket layer 962a and the second gasket layer 962b, e.g., the thicker portions of the first frame 914a and the second frame 914b, which may be made of a stiffer material than the first gasket layer 962a and the second gasket layer 962b, may act as a primary load path and may exhibit a higher stiffness that limits the amount of compressive deflection that may occur in the frame assembly 900, thereby acting to offload some of the compressive force that is directed through the layer stack of the frame assembly from the first gasket layer 962a and the second gasket layer 962b. The amount of compression of the first gasket layer 962a and the second gasket layer 962b may thus be limited, for example, by the distance X (or at least a distance based on the distance X) as compared with implementations in which the compressive loads through the frame assembly pass entirely through the first gasket layer 962a and the second gasket layer 962b.

FIG. 10 depicts a partial cross-sectional view of another example frame assembly that is somewhat similar to that of FIGS. 7 and 8. As with FIG. 9, to avoid undue repetition, elements in the implementation of FIG. 10 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIG. 10 unless indicated otherwise. In the interest of conciseness, discussion of these elements that would be redundant of earlier discussion herein of similar elements is not provided, with the understanding that the earlier discussion of such elements is applicable to these similar elements in FIG. 10.

In FIG. 10, the separator plate is a single, continuous or unitary part, e.g., machined out of a single piece of material or stamped/forged from a blank. Thus, in the implementation of FIG. 10, the separator plate 1006 has a first wall element and a second wall element that form the first raised feature 1026a and the second raised feature 1026b, but the first wall element and the second wall element are continuous with the remainder of the separator plate 1006 (instead of being separate parts that are welded, brazed, or soldered to a separate sheet of material). Such an implementation may avoid the need for welding, brazing, or soldering and may thus be more amenable to more cost-effective mass-production than implementations in which the separator plate is a multi-piece assembly.

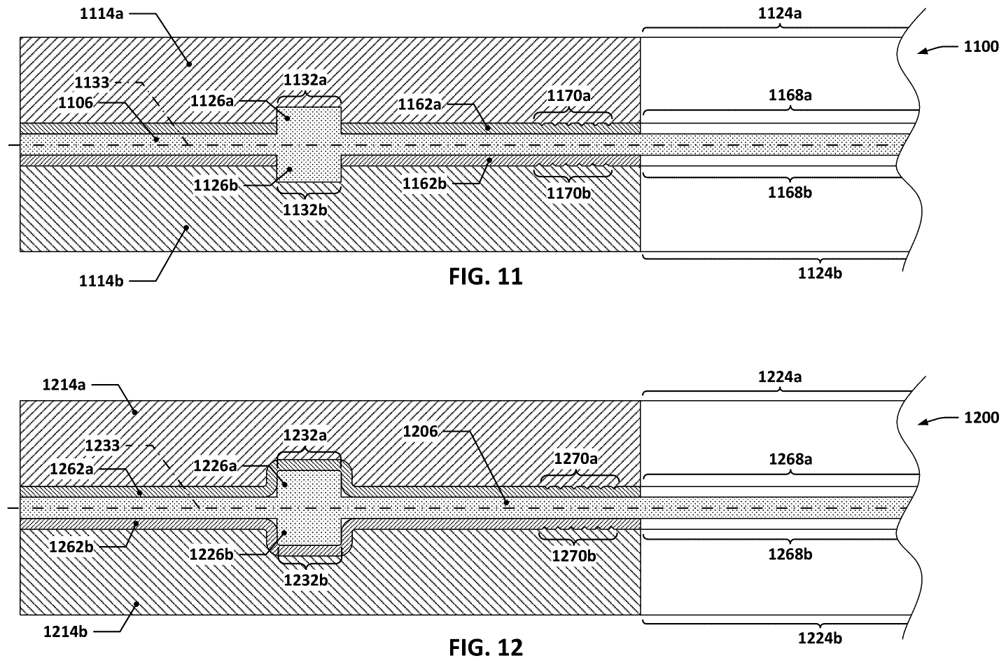

FIG. 11 depicts a partial cross-sectional view of another example frame assembly that is somewhat similar to that of FIGS. 7 and 8. As with previous Figures, to avoid undue repetition, elements in the implementation of FIG. 11 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIG. 11 unless indicated otherwise. In the interest of conciseness, discussion of these elements that would be redundant of earlier discussion herein of similar elements is not provided, with the understanding that the earlier discussion of such elements is applicable to these similar elements in FIG. 11.

In FIG. 11, the portions of the first gasket layer 1162a and the second gasket layer 1162b that align with the first raised feature 1126a and the second raised feature 1126b have been removed prior to installation of the first gasket layer 1162a and the second gasket layer 1162b. In some such implementations, e.g., ones in which the first raised feature 1126a and/or the second raised feature 1126b is or are in the form of a continuous wall or walls that extends completely around the first flow field aperture 1124a and/or the second flow field aperture 1124b, the first gasket layer 1162a and/or the second gasket layer 1162b may be multi-part components. For example, the first gasket layer 1162a may have an inner portion that is sized to lie within the first raised feature 1126a and an outer portion that is sized to lie outside of the region bounded by the first raised feature 1126a. In other such implementations, there may be multiple instances of the first raised feature 1126a and/or the second raised feature 1126b and the first gasket layer 1162a and/or the second gasket layer 1162b may be continuous but may have holes or openings therethrough that may be positioned and sized such that the first raised features 1126a and/or the second raised features 1126b may pass therethrough.

Such implementations may provide the benefit that the first raised feature 1126a and/or the second raised feature 1126b may serve as locating features that may help position the first gasket layer 1162a and/or the second gasket layer 1162b relative to the first frame 1114a and/or the second frame 1114b, respectively. Such implementations may also avoid placing the material of the first gasket layer 1162a and/or the second gasket layer 1162b within the interface between the first raised feature 1126a and the first receiving feature #1132a or the interface between the second raised feature 1126b and the second receiving feature 1132b, respectively. This may reduce the amount of force that may need to be applied to compress the first frame 1114a, the first gasket layer 1162a, the separator plate 1106, the second gasket layer 1162b, and the second frame 1114b together during assembly, as there is no need to compress the first gasket layer 1162a and/or the second gasket layer 1162b so as to shear out or distend portions of the first gasket layer 1162a and/or the second gasket layer 1162b.

It will be understood that while FIG. 11 depicts the separator plate 1106 as a single-piece component (like the separator plate 1006), the implementation of FIG. 11 may also be practiced with separator plates that are multi-piece assemblies, e.g., such as the separator plate 706.

FIG. 12 depicts a partial cross-sectional view of another example frame assembly that is somewhat similar to that of FIGS. 7 and 8. As with previous Figures, to avoid undue repetition, elements in the implementation of FIG. 12 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIG. 12 unless indicated otherwise. In the interest of conciseness, discussion of these elements that would be redundant of earlier discussion herein of similar elements is not provided, with the understanding that the earlier discussion of such elements is applicable to these similar elements in FIG. 12.

In FIG. 12, the first receiving feature 1232a and the second receiving feature 1232b are sized so as to have transverse widths, e.g., along directions extending parallel to the midplane 1233 and perpendicular to the paths followed by the first raised feature 1226a and the second raised feature 1226b, that are wider than the transverse widths of the first raised feature 1226a and the second raised feature 1226b. For example, the transverse widths of the first receiving feature 1232a and the second receiving feature 1232b may be sized to be larger than the transverse widths of the first raised feature 1226a and the second raised feature 1226b, respectively, by an amount equal to, or slightly less than, approximately twice the thickness of the first gasket layer 1262a and the second gasket layer 1262b, respectively. Such sizing avoids scenarios in which the first raised feature 1226a and the second raised feature 1226b and the first receiving feature 1232a and the second receiving feature 1232b act as punches and dies by shearing out the portions of the first gasket layer 1262a and the second gasket layer 1262b trapped therebetween. Instead, the first gasket layer 1262a and the second gasket layer 1262b may be plastically deformed while retaining their structural integrity, i.e., there may be no perforation or shearing of the material of the first gasket layer 1262a and/or the second gasket layer 1262b when the first frame 1214a, the first gasket layer 1262a, the separator plate 1206, the second gasket layer 1262b, and the second frame 1214b are compressed together.

Such implementations may be beneficial in that they provide for a tight fit or engagement between the first raised feature 1226a and the first frame 1214a, as well as between the second raised feature 1226b and the second frame 1214b, that may act to prevent potential outward movement of the first frame 1214a and the second frame 1214b when pressure is applied to the interior of the electrochemical cell.

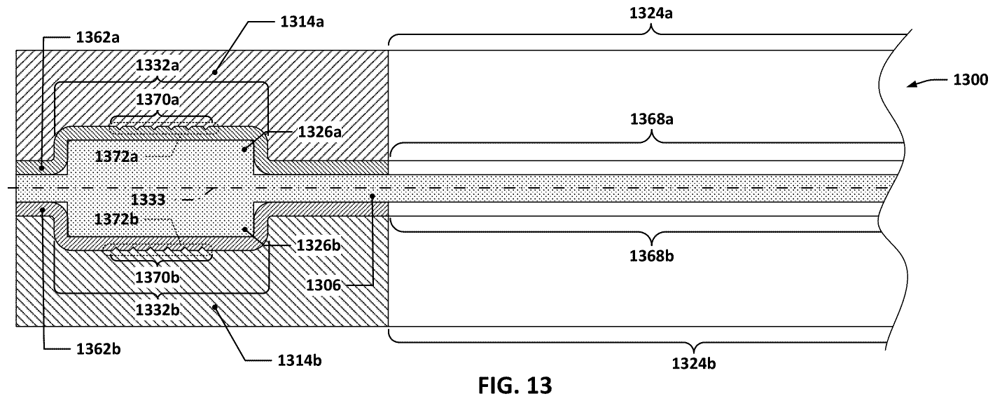

FIG. 13 depicts a partial cross-sectional view of another example frame assembly that is somewhat similar to that of FIGS. 7 and 8. As with previous Figures, to avoid undue repetition, elements in the implementation of FIG. 13 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIG. 13 unless indicated otherwise. In the interest of conciseness, discussion of these elements that would be redundant of earlier discussion herein of similar elements is not provided, with the understanding that the earlier discussion of such elements is applicable to these similar elements in FIG. 13.

In the frame assembly of FIG. 13, the separator plate 1306 is similar to the separator plate 1006, but with the first raised feature 1326a and the second raised feature 1326b somewhat larger. Additionally, the first ridge features 1370a and the second ridge features 1370b have been relocated such that they are positioned so as to overlap with the first receiving feature 1332a and the second receiving feature 1332b, respectively. Thus, the first clamping region 1372a and the second clamping region 1372b of the first gasket layer 1362a and the second gasket layer 1362b, respectively, are collocated with the first raised feature 1326a/first receiving feature 1332a and the second raised feature 1326b/second receiving feature 1332b, respectively.

Such implementations may provide for a more compact first frame 1314a and second frame 1314b since the same portions of the first frame 1314a and second frame 1314b may be used to provide both the anti-bulge functionality afforded by the use of the first raised feature(s) 1326a/first receiving feature(s) 1332a and the second raised feature(s) 1326b/second receiving feature(s) 1332b, as well as the sealing functionality afforded by the use of the first ridge features 1370a and the second ridge features 1370b. This allows for a smaller frame assembly to be used for a given flow field aperture size, or for a larger flow field aperture size to be used for a given frame assembly size. In some such implementations, there may also be additional first or second ridged features that are located inwards of the first raised features or the second raised features, e.g., similar to how the first ridged features and/or the second ridged features in earlier examples are positioned.

In the examples discussed above, the separator plates were characterizable as having variable thickness, e.g., having increased thicknesses where the first raised feature(s) and/or the second raised feature(s) are and reduced thicknesses elsewhere. However, in some implementations, the separator plates may have a generally uniform thickness throughout. In such implementations, the separator plates may, for example, still have one or more raised features, but may also have a corresponding recessed feature for each such raised feature that is located on the opposite side of the separator plate from that raised feature and positioned in the same location. For example, the separator plate may be made by stamping a sheet of material to emboss a plurality of embossed features in the sheet of material. Each such embossed feature may protrude from one side of the sheet of material but may extend into the other side of the sheet of material. Put another way, at each raised feature location on such a separator plate there may be a convex surface that provides the raised feature and a corresponding concave surface that provides a corresponding recessed feature. Each pair of concave and convex surfaces may generally have the same profile but be offset from one another by the thickness of the sheet of material.

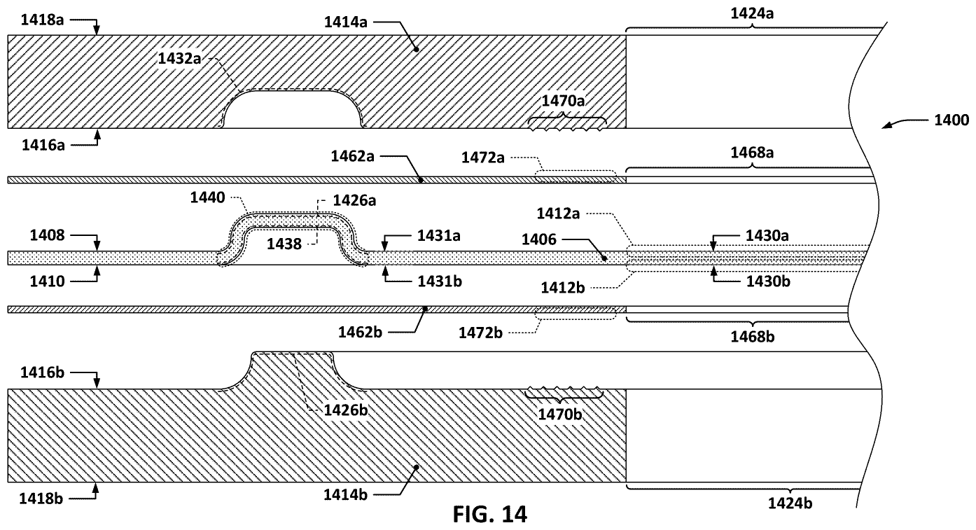

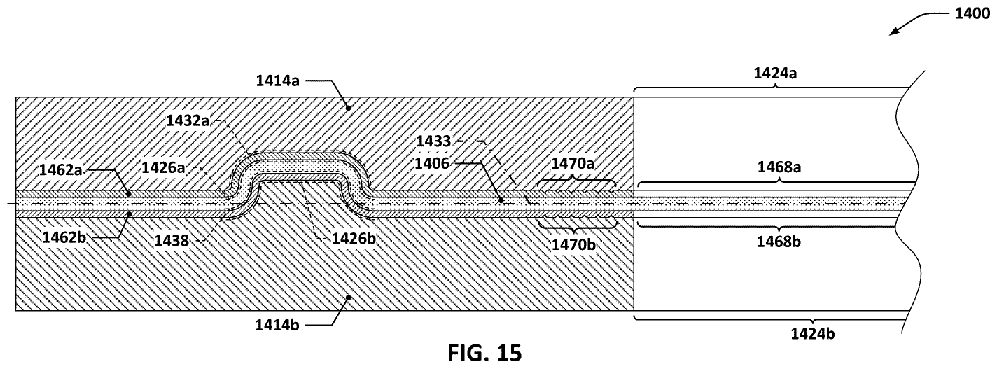

FIG. 14 depicts a partial cross-sectional exploded view of another example frame assembly that is somewhat similar to that of FIGS. 7 and 8. FIG. 15 depicts the example frame assembly of FIG. 14 but in an unexploded, assembled state. As with previous Figures, to avoid undue repetition, elements in the implementation of FIGS. 14 and 15 that are analogous to elements shown in FIGS. 7 and 8 are called out with callouts that share the same last two digits as those analogous elements in FIGS. 7 and 8. Thus, the discussion provided above with respect to the elements of the implementation of FIGS. 7 and 8 will be understood to be equally applicable to the analogous elements in FIGS. 14 and 15 unless indicated otherwise. In the interest of conciseness, discussion of these elements that would be redundant of earlier discussion herein of similar elements is not provided, with the understanding that the earlier discussion of such elements is applicable to these similar elements in FIGS. 14 and 15.

In FIGS. 14 and 15, the separator plate 1406 is a separator plate that was formed from a sheet of material, e.g., metal, that was stamped so as to create an embossed feature 1440 that simultaneously provides a first raised feature 1426a and a corresponding recessed feature 1438 in the separator plate 1406. The first raised feature 1426a is, in this case, a stamped wall embossed feature 1440 that extends around the periphery of at least the first flow field region 1412a and extends into a first receiving feature 1432a.

In addition to the separator plate 1406 being different in construction from previously discussed examples, the frame assembly 1400 also differs from the previously discussed examples in that the second raised feature 1426b is not located on the separator plate 1406, but is instead located on the second frame 1414b. For example, each second raised feature 1426b may be positioned on the first side 1416b of the second frame 1414b such that that second raised feature 1426b is aligned with a corresponding recessed feature 1438 on the separator plate 1406.

The recessed feature 1438 may be sized so as to have a transverse width, e.g., along a direction extending parallel to the midplane 1433 and perpendicular to the path followed by the first raised feature 1426a, that is wider than the transverse width of the first raised feature 1426a. For example, the transverse width of the recessed feature 1438 may be sized to be larger than the transverse width of the first raised feature 1426a by an amount equal to, or slightly less than, approximately twice the thickness of the second gasket layer 1462b. Such sizing avoids a scenario in which the thickness of the second gasket layer 1462b prevents the second raised feature 1426b from being able to be fully inserted into the recessed feature 1438 when the first frame 1414a, the first gasket layer 1462a, the separator plate 1406, the second gasket layer 1462b, and the second frame 1414b are compressed together.

The implementation of FIG. 14 does feature an instance in which a polymeric material is used to provide a raised feature. However, unlike the case in which a polymeric raised feature may be inserted through a hole or aperture in the separator plate (which may allow the interior edge of such a hole or aperture to act, in effect, as a knife edge that may cut into the polymeric material of the raised feature, eventually causing it to shear off), in the implementation of FIG. 14, the recessed feature 1438 will generally feature an at least somewhat rounded edge around the perimeter of the recessed feature and the lateral loading on the second raised feature 1426b by the separator plate 1406 will be distributed across the interior sidewalls of the recessed feature 1438, thereby reducing the stress on the second raised feature 1426b and reducing the potential for failure in the second raised feature 1426b when laterally loaded.

The implementation of FIG. 14 also offers an additional benefit in that the separator plate 1406 may be significantly cheaper and faster to manufacture than separator plate designs discussed earlier herein.

In the above examples, the first frames and the second frames have generally been single-piece components. However, in some implementations, the first frames and/or the second frames may be multi-part components. For example, a first frame and/or a second frame may have a receiving frame and a corresponding frame insert. The receiving frame may have a feature or features in it that may be designed to interface with, and receive, the frame insert. The assembled receiving frame and frame insert may, when assembled, serve as one of the frames of a frame assembly.

Such implementations may, for example, allow for a common receiving frame design to be used with two different types of frame insert design. Such implementations may also allow for different materials to be used, e.g., one or both frame inserts may be made of a metal alloy, while the receiving frames and potentially the other of the frame inserts (if not both made of metal alloy) may be made of polymeric materials. This may allow for the interface between the receiving feature(s) in the frame assembly and the raised feature(s) in the separator plate to be, for example, a metal-metal contact interface, which may be stronger than can be achieved with a polymer-metal contact interface.

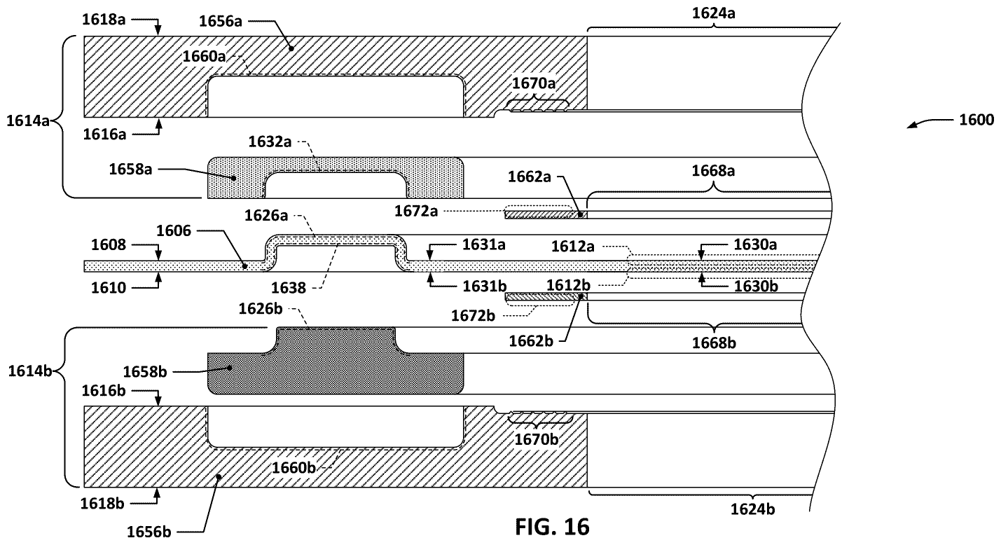

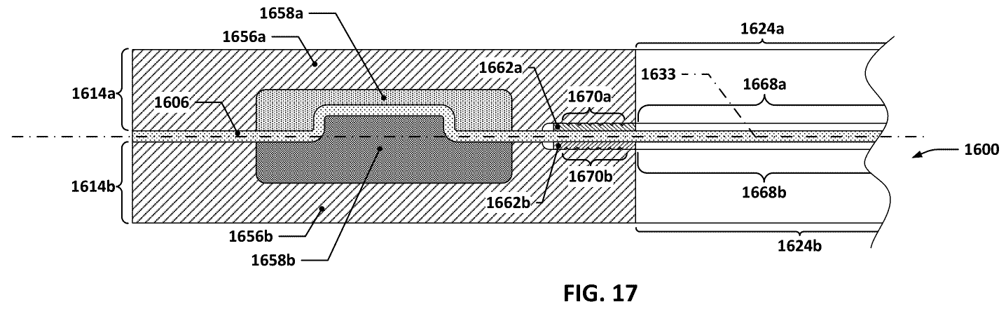

FIG. 16 depicts a partial cross-sectional exploded view of another example frame assembly that is somewhat similar to that of FIGS. 14 and 15. FIG. 17 depicts the example frame assembly of FIG. 16 but in an unexploded, assembled state. As with previous Figures, to avoid undue repetition, elements in the implementation of FIGS. 16 and 17 that are analogous to elements shown in FIGS. 14 and 15 are called out with callouts that share the same last two digits as those analogous elements in FIGS. 14 and 15. Thus, the discussion provided above with respect to the elements of the implementation of FIGS. 14 and 15 will be understood to be equally applicable to the analogous elements in FIGS. 16 and 17 unless indicated otherwise. In the interest of conciseness, discussion of these elements that would be redundant of earlier discussion herein of similar elements is not provided, with the understanding that the earlier discussion of such elements is applicable to these similar elements in FIGS. 16 and 17.

As in the frame assembly 1400, the frame assembly 1600 includes a first frame 1614a and a second frame 1614b. The first frame 1614a is a two-piece frame including a first receiving frame 1656a and a first frame insert 1658a. The second frame 1614b is similarly a two-piece frame and includes a second receiving frame 1656b and a second frame insert 1658b.

The first receiving frame 1656a may have a first recess 1660a in a surface of the first receiving frame 1656a that is part of the first side 1616a of the first frame 1614a. The first recess 1660a may be sized and shaped so as to receive the first frame insert 1658a therein and securely constrain the first frame insert 1658a from moving in directions parallel to the midplane 1633, e.g., transverse to the frame assembly 1600. Similarly, the second receiving frame 1656b may have a second recess 1660b in a surface of the second receiving frame 1656b that is part of the first side 1616b of the second frame 1614b. The second recess 1660b may be sized and shaped so as to receive the second frame insert 1658b therein and to securely constrain the second frame insert 1658b from moving in directions parallel to the midplane 1633, e.g., transverse to the frame assembly 1600.

In this example, the first frame insert 1658a has a generally C-shaped cross-section and is inserted or fit snugly into the first recess 1660a such that the spine of the C-shape is pressed against the bottom of the first recess 1660a. The “open” part of the C-shape may serve as the recessed feature 1638 of the depicted implementation.

Similarly, the second frame insert 1658b has a generally T-shaped cross-section, with the top of the “T” being sized to fit snugly into the second recess 1660b, which may have a generally rectangular cross-section. The vertical part of the “T” is a short stub that, when the second frame insert 1658b is inserted into the second recess 1660b, acts as the second raised feature 1626b.

The first receiving frame 1656a and the second receiving frame 1656b, however, are of identical design in this example and are thus interchangeable. The first frame insert 1658a and the second frame insert 1658b may thus each be installed or inserted into the first recess 1660a of the first receiving frame 1656a or the second recess 1660b of the second receiving frame 1656b.

The separator plate 1606 in this example is similar to the separator plate 1406, e.g., a stamped sheet metal part that has an embossed feature that provides both the first raised feature 1626a and the recessed feature 1638. Accordingly, the first raised feature 1626a may be inserted into the first receiving feature 1632a, and the second raised feature 1626b may be inserted into the recessed feature 1638.

Also visible in FIGS. 16 and 17 is a different configuration of the first gasket layer 1662a and the second gasket layer 1662b. In this example, neither the first gasket layer 1662a nor the second gasket layer 1662b extend to the first recess 1660a or the second recess 1660b. Instead, the first receiving frame 1656a may have a corresponding recessed region along the inner perimeter that defines the first flow field aperture 1624a; this corresponding recessed region may be recessed by a distance generally equal or lesser to the thickness of the first gasket layer 1662a. The first receiving frame 1656a may also include one or more first ridge features 1670a that are configured to grip the first gasket layer 1662a and locally deform the first gasket layer 1662a to form a tighter seal between the first receiving frame 1656a and the first gasket layer 1662a.

Similarly, the second receiving frame 1656b may have a corresponding recessed region along the inner perimeter that defines the second flow field aperture 1624b. The corresponding recessed region may be recessed by a distance generally equal or lesser to the thickness of the second gasket layer 1662b. The second receiving frame 1656b may also include one or more second ridge features 1670b that are configured to grip the second gasket layer 1662b and locally deform the second gasket layer 1662b to form a tighter seal between the second receiving frame 1656b and the second gasket layer 1662b.

In the examples above, the raised features on the separator plates have generally been in the form of wall elements, e.g., generally elongate structures that may follow a path or paths along the perimeter of a frame or around or proximate to the flow field aperture of the frame. However, in other implementations, the raised features may instead be domed embossed features, e.g., dome-shaped bumps, that may be formed in the separator plate. In such cases, a plurality of such raised features may be distributed throughout regions such as the shaded regions 178 or 178a/b, respectively, in FIGS. 3 and 4, respectively.

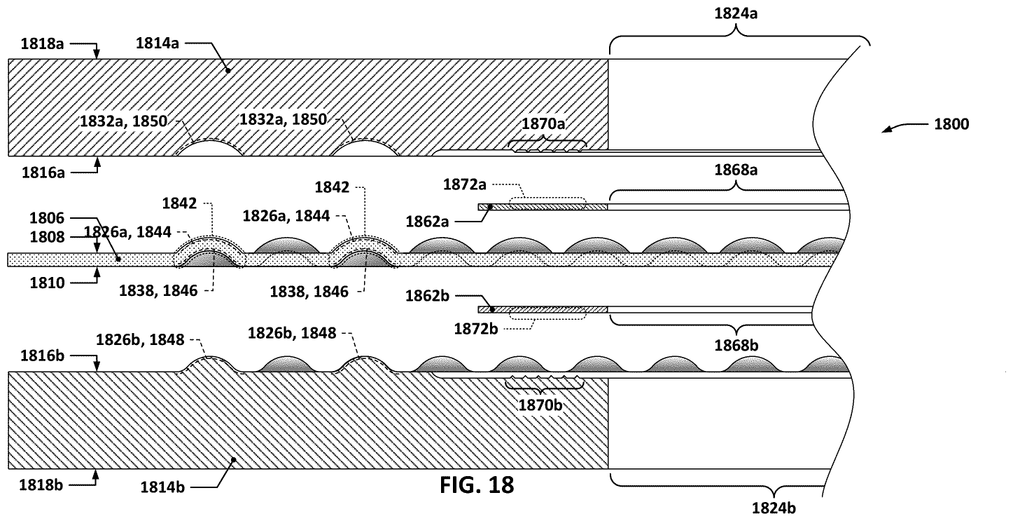

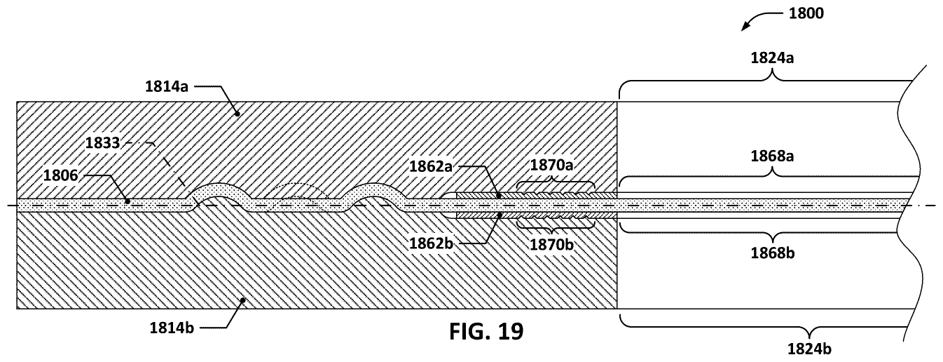

FIG. 18 depicts a partial cross-sectional exploded view of another example frame assembly that is somewhat similar to that of FIGS. 14 and 15, e.g., in that the separator plate is a stamped sheet metal part with embossed features. FIG. 19 depicts the example frame assembly of FIG. 18 but in an unexploded, assembled state. As with previous Figures, to avoid undue repetition, elements in the implementation of FIGS. 18 and 19 that are analogous to elements shown in FIGS. 14 and 15 are called out with callouts that share the same last two digits as those analogous elements in FIGS. 14 and 15. Thus, the discussion provided above with respect to the elements of the implementation of FIGS. 14 and 15 will be understood to be equally applicable to the analogous elements in FIGS. 18 and 19 unless indicated otherwise. In the interest of conciseness, discussion of these elements that would be redundant of earlier discussion herein of similar elements is not provided, with the understanding that the earlier discussion of such elements is applicable to these similar elements in FIGS. 18 and 19.

As can be seen in FIGS. 18 and 19, the separator plate 1806 includes a plurality of domed embossed features 1842 that have convex domed surfaces 1844 that provide the first raised features 1826a on the first side 1808 of the separator plate 1806. The domed embossed features 1842 also provide concave dome surfaces 1846 that provide the corresponding recessed features 1838 in the second side 1810 of the separator plate 1806.

The first frame 1814a has first receiving features 1832a, e.g., concave domed recesses, that may be sized such that concave domed surfaces 1850 of the concave domed recesses come into contact with corresponding ones of the convex domed surfaces 1844 of the domed embossed features 1842 when the first frame 1814a is used to compress the separator plate 1806 against the second frame 1814b. Similarly, the second frame 1814b has second raised features 1826b that have domed convex surfaces 1848 that are sized such that the domed convex surfaces 1848 of the second raised features 1826b come into contact with the concave domed surfaces 1846 of the domed embossed features 1842 when the first frame 1814a is used to compress the separator plate 1806 against the second frame 1814b.

The use of domed embossed features to provide the first raised features may be beneficial in that the domed embossed features, particularly if they are in the form of spherical or obround domed caps, may be extremely resistant to being collapsed. This may prevent, for example, a situation in which an embossed feature serving as a first raised feature may, when the first frame or the second frame are subjected to internal pressures within the first flow field aperture or the second flow field aperture, respectively, be partially or completely flattened due to the outward pressure that is exerted on the portions of the first frame or the second frame that have the first receiving feature(s) or the second receiving feature(s). Such pressure may, for example, push those portions of the first frame or the second frame outward, thereby causing the first frame or the second frame to try and “smooth out” the embossed feature. Domed embossed features, by virtue of their higher strength as compared with linear embossed features, for example, may be much more resistant to such deformation and may thus offer a more robust mechanism for interlocking the first frames and the second frames with their respective separator plates in order to stiffen the first frames and the second frames and prevent undesirable outward bulging or distension thereof.

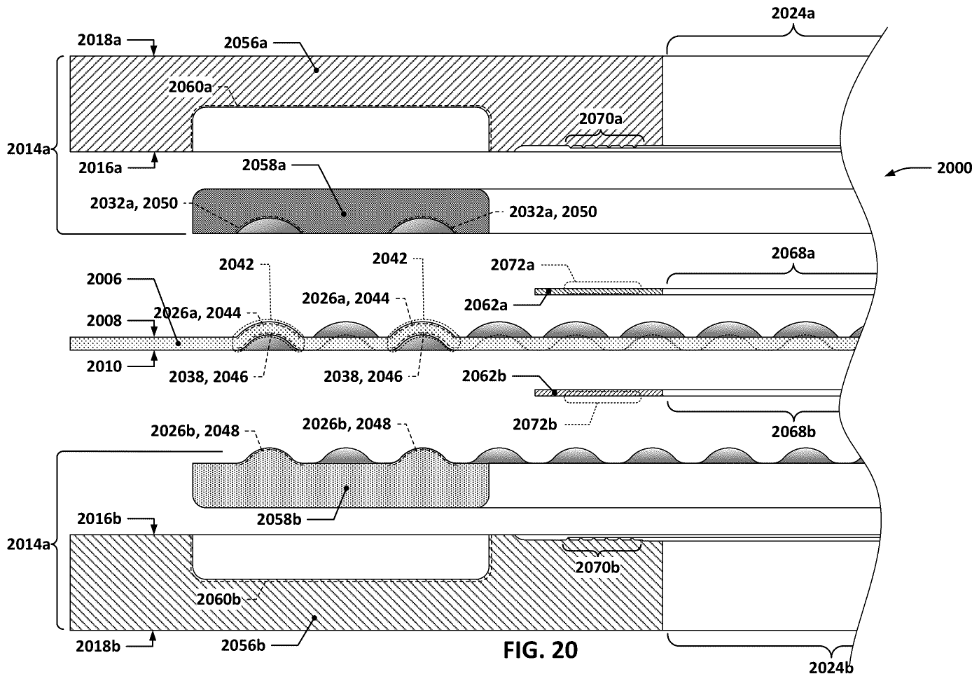

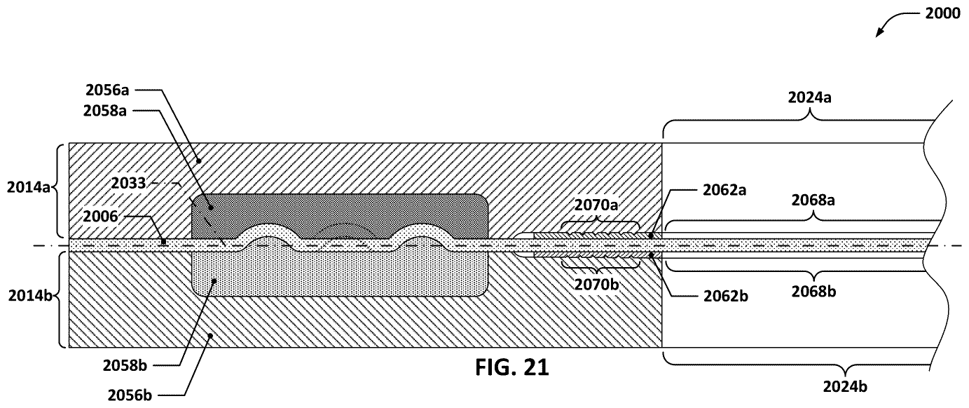

FIG. 20 depicts a partial cross-sectional exploded view of another example frame assembly that is a blend of the concept in FIGS. 16 and 17 with the concept in FIGS. 18 and 19. FIG. 21 depicts the example frame assembly of FIG. 20 but in an unexploded, assembled state. As with previous Figures, to avoid undue repetition, elements in the implementation of FIGS. 20 and 21 that are analogous to elements shown in FIGS. 16 through 19 are called out with callouts that share the same last two digits as those analogous elements in FIGS. 16 through 19. Thus, the discussions provided above with respect to the elements of the implementations of FIGS. 16 through 19 will be understood to be equally applicable to the analogous elements in FIGS. 20 and 21 unless indicated otherwise. In the interest of conciseness, discussion of these elements that would be redundant of earlier discussion herein of similar elements is not provided, with the understanding that the earlier discussion of such elements is applicable to these similar elements in FIGS. 20 and 21.

As can be seen in FIGS. 20 and 21, the first frame insert 2058a in this example has a plurality of domed recesses that provide the first receiving features 2032a, e.g., via domed concave surfaces 2050. Similarly, the second frame insert 2058b in this example has a plurality of domed protrusions that provide the second raised features 2026b. The first frame insert 2058a and the second frame insert 2058b may, for example, function similarly to the first frame insert 1658a and the second frame insert 1658b.

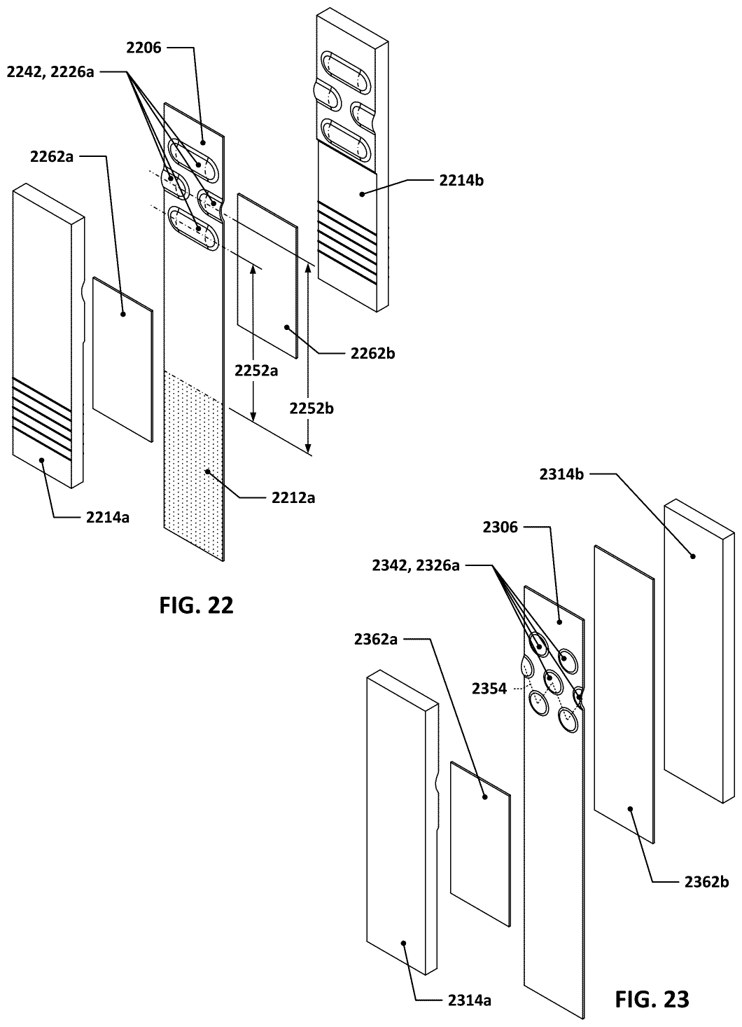

FIGS. 22 through 24 depict isometric exploded views of removed sections of various example frame assemblies that include domed embossed features that serve as first raised features.

In FIG. 22, a portion of a separator plate 2206 is shown, as are portions of a first frame 2214a, a second frame 2214b, a first gasket layer 2262a, and a second gasket layer 2262b. As can be seen, the separator plate 2206 features a plurality of domed embossed features 2242 that provide first raised features 2226a. The first raised features 2226a may be arranged at varying distances from a first flow field region 2212a, e.g., the centers of some of the first raised features 2226a may be positioned at locations that are spaced a first distance 2252a from the first flow field region 2212a while the centers of some others of the first raised features 2226a may be positioned at locations that are spaced a second distance 2252b from the first flow field region 2212a. The second distance 2252b may, for example, be larger than the first distance 2252a. Additional first raised features 2226a may be positioned even further from the first flow field region, if desired.

The domed embossed features 2242 in this example are in the form of obround domes, e.g., opposing halves of a spherical dome that are joined by a segment of a cylindrical surface that has a center axis that intersects the centers of curvature of the spherical dome halves.

FIG. 23 is similar to FIG. 22 and shows portions of a separator plate 2306, a first frame 2314a, a second frame 2314b, a first gasket layer 2362a, and a second gasket layer 2362b. As can be seen, the separator plate 2306 features a plurality of domed embossed features 2342 that provide first raised features 2326a. The first raised features 2326a may be arranged along a zig-zag path 2354, e.g., with first raised features 2326a located at each vertex of the zig-zag path 2354. There may be multiple zig-zag paths that the first raised features 2326a may be positioned along.

The domed embossed features 2342 in this example are in the form of spherical domes, e.g., domes having a surface with a constant radius of curvature.

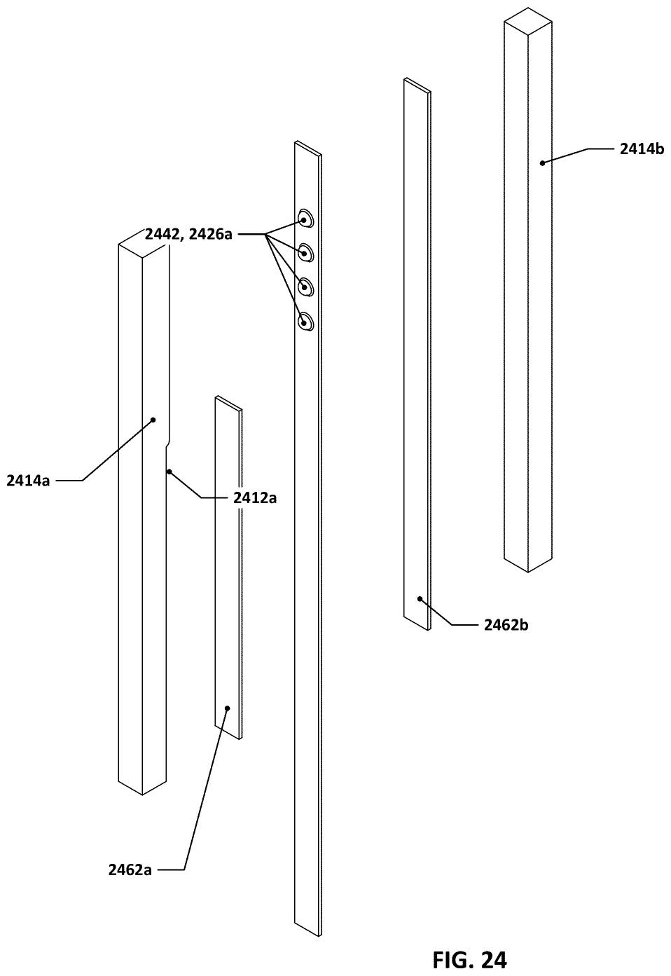

In the examples of FIGS. 22 and 23, the domed embossed features have relatively shallow depths, which may limit the ability of the separator plates to interlock with the first frames. In FIG. 24, another example is shown that includes a separator plate 2406, a first frame 2414a, a second frame 2414b, a first gasket layer 2462a, and a second gasket layer 2462b. In contrast to the previously discussed domed embossed features, the domed embossed features 2442 that provide the first raised features 2426a are more pronounced, e.g., hemispherical. Such implementations may require that the first frame 2414a be thicker in order to have sufficient thickness to accommodate such larger height first raised features 2426a, but may, at the same time, provide more resistance against outward displacement of the sides of the first frame 2414a.

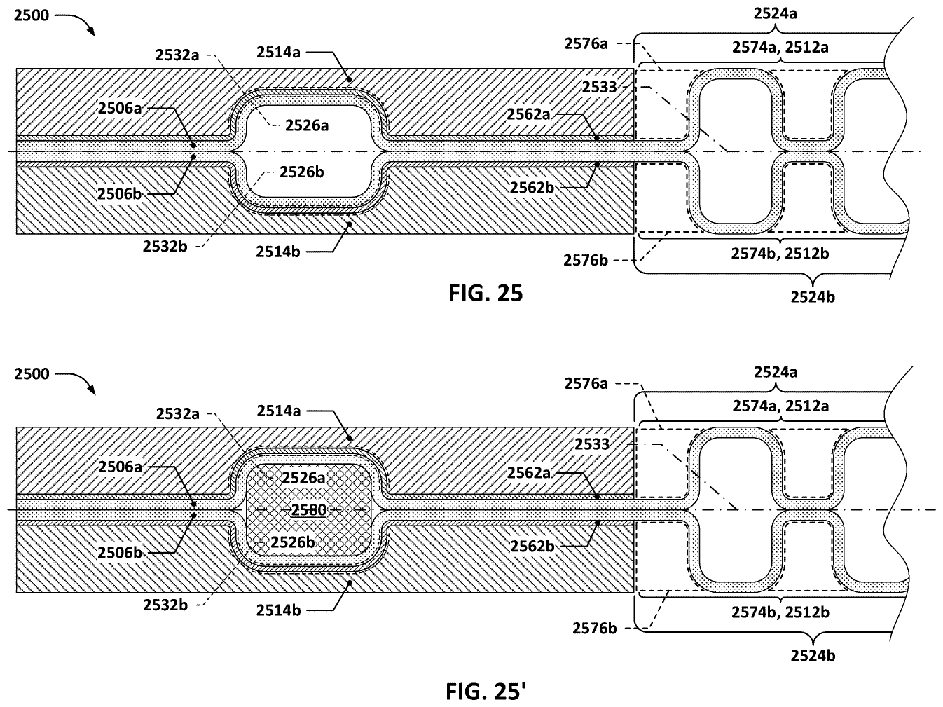

FIGS. 25 and 25′ depict an example frame assembly 2500 featuring a multi-piece separator plate. The frame assemblies 2500 of FIGS. 25 and 25′ are similar to the frame assembly 1200 of FIG. 12, except that the separator plate is a two-piece separator plate. As with previous Figures, to avoid undue repetition, elements in the implementation of FIGS. 25 and 25′ that are analogous to elements shown in FIG. 12 are called out with callouts that share the same last two digits as those analogous elements in FIG. 12. Thus, the discussion provided above with respect to the elements of the implementation of FIG. 12 will be understood to be equally applicable to the analogous elements in FIGS. 25 and 25′ unless indicated otherwise. In the interest of conciseness, discussion of these elements that would be redundant of earlier discussion herein of similar elements is not provided, with the understanding that the earlier discussion of such elements is applicable to these similar elements in FIGS. 25 and 25′.

As seen in FIGS. 25 and 25′, a frame assembly 2500 having a first frame 2514a and a second frame 2514b is depicted. As mentioned above, the separator plate in this example is a two-piece separator plate featuring a first portion 2506a and a second portion 2506b. The first portion 2506a and the second portion 2506b are both, in this example, stamped sheet metal components that have first raised features 2526a and second raised features 2526b, respectively, embossed into them. The first portion 2506a and the second portion 2506b may be placed back-to-back, i.e., such that the raised features of each portion extend away from the other portion, thereby forming a separator plate that has first raised features 2526a and second raised features 2526b that respectively extend into first receiving features 2532a and second receiving features 2532b that are located in the first frame 2514a and the second frame 2514b, respectively. In some implementations, the first portion 2506a and the second portion 2506b may be joined together, e.g., via welds (resistance or spot welds, for example), brazing, or soldering. However, in other implementations, the first portion 2506a and the second portion 2506b may simply be in contact with one another without necessarily being joined together.

As can be seen, the first portion 2506a has embossed features in a first flow field region 2512a defined by a first flow field aperture 2524a in the first frame 2514a. The embossed features in the first flow field region 2512a form a first flow field 2574a that may define, for example, a plurality of first flow field channels 2576a that may serve to distribute fluids across a surface of, for example, an MEA, porous transport layer (PTL), or gas diffusion layer (GDL) that may be placed adjacent to the second side of the first frame 2514a. It will be understood that such flow fields may also be provided by embossed features that form a distributed plurality of small, mesa- or island-like structures that may act like a pin field to distribute flow throughout the region in which such structures are dispersed. Similarly, the second portion 2506b has embossed features in a second flow field region 2512b defined by a second flow field aperture 2524b in the second frame 2514b. The embossed features in the second flow field region 2512b form a second flow field 2574b that may similarly define, for example, a plurality of second flow field channels 2576b that may serve to distribute fluids across a surface of, for example, an MEA, porous transport layer (PTL), or gas diffusion layer (GDL) that may be placed adjacent to the second side of the second frame 2514b. Such flow fields, for example, may also be provided by embossed features that form a distributed plurality of small, mesa- or island-like structures that may act like a pin field to distribute flow throughout the region in which such structures are dispersed.

In the example of FIG. 25, the empty space between the first raised feature 2526a and the second raised feature 2526b is left hollow. However, in the example of FIG. 25′, a filler 2580 is installed in between the first portion 2506a and the second portion 2506b of the separator plate. The filler 2580 may, for example, be a polymeric structure that is sized to fit snugly within the recessed portions of the embossed first raised feature 2526a and second raised feature 2526b. For example, if the first raised feature 2526a and second raised feature 2526b both follow rectangular paths extending along the interior of the outer perimeter of the frame assembly, the filler 2580 may be a rectangular “frame” that fits within the rectangular first raised feature 2526a and rectangular second raised feature 2526b.

In some instances, the filler 2580 may be sized so as to be lightly press-fit into the recessed portion(s) of the embossed first raised feature 2526a and second raised feature 2526b, thereby allowing the first portion 2506a and the second portion 2506b of the separator plate to be joined together to form an assembled separator plate before being installed into the frame assembly 2500.

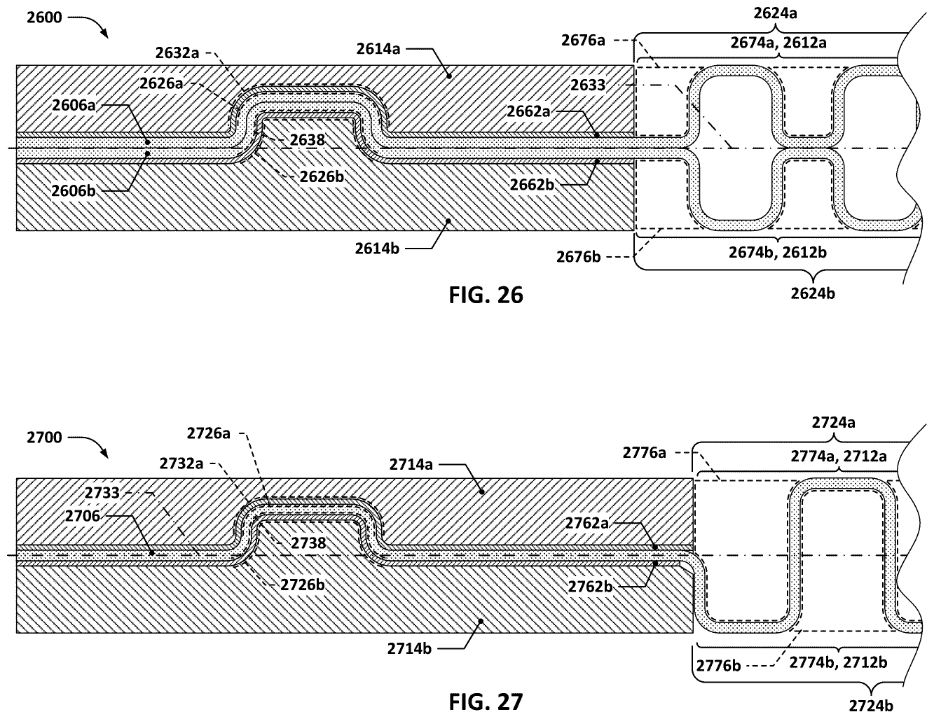

FIG. 26 depicts another example frame assembly featuring a multi-piece separator plate. The frame assembly 2600 of FIG. 26 is identical to the frame assembly 2500 except that a) the second portion 2606 has an embossed feature that provides a recessed feature 2638 and b) the second raised feature 2626b is located on the second frame 2614b and extends into the recessed feature 2638. In some such implementations, the first portion 2506a and the second portion 2506b of the separator plate FIG. 26 may first each be separately stamped to produce the embossed features that provide the first flow field 2674a and the second flow field 2684b, respectively. The stamped first portion 2506a and the stamped second portion 2506b may then be positioned adjacent to one another, e.g., back-to-back, and then subjected to a third stamping operation that may stamp the first raised feature 2626a and the recessed feature 2638 into the first portion 2606a and the second portion 2606b simultaneously.

FIG. 27 depicts an example frame assembly featuring a single-piece separator plate with integral flow fields. In this example, the separator plate 2706 is very similar to the separator plate 1406 in the frame assembly 1400 discussed with respect to FIGS. 14 and 15, but has additional embossed features in the first flow field region 2712a and the second flow field region 2712b that simultaneously provide the first flow field 2774a and the second flow field 2774b using a single sheet metal stamping. In this example, the embossed features in the separator plate 2706 that provide the first flow field 2774a and the second flow field 2774b may include some embossed features that extend to one side of the separator plate 2706 and other embossed features that extend to the other side of the separator plate 2706. The first flow field channels 2776a and the second flow field channels 2776b are, in effect, complements of each other, with each first flow field channel 2776a fitting in between adjacent second flow field channels 2776b (or between an adjacent second flow field channel 2776b and the first frame 2714a), and each second flow field channel 2776b fitting in between adjacent first flow field channels 2776c (or in between an adjacent first flow field channel 2776a and the second frame 2714b). Such implementations allow for a single-piece separator plate/first flow field/second flow field, thereby reducing the number of parts needed and reducing manufacturing and/or assembly complexity (and cost).

It will be noted that the separator plates of each of the frame assemblies 2500 through 2700 may also be used in any of the other example frame assemblies discussed herein-even in frame assemblies where the raised features that engage with the frames to limit radial expansion of the frames when pressurized are not embossed features. For example, the separator plate 706 of the frame assembly 700 may have stamped, embossed features within the flow field region(s) that may be used to provide the flow fields for that frame assembly 700.

Similarly, it will be understood that some separator plates may be machined so as to have a thickened section within the flow field region(s). In such implementations, the channels or other flow-permitting features of the flow fields may be machined directed into the thickened section, e.g., similar to if the separator plate 506, first flow field 574a, and second flow field 574b of the frame assembly 500 were to be made as a unitary, single-piece part instead of as separate pieces.

It will also be understood that the first gasket layers 2562a/2662a/2762a and/or the second gasket layers 2562b/2662b/2762b may be configured similarly to how other gasket layers discussed herein are configured, e.g., being gripped by first or second ridge features, extending into the interface between the first raised feature and the first receiving feature (or not extending that far), etc.

It will be readily apparent that various elements from the above-discussed examples may be implemented in other examples discussed above or in other ways not explicitly described above. For example, for a separator plate in which the first raised features are provided by embossed features, the separator plate may be stamped so that one or more first raised features protrude from the first side of the separator plate, while other raised features protrude from the second side of the separator plate.

In another example, the first and/or second ridge features, if used, may be located in the various positions discussed herein in any of the specific examples discussed above.

In another example, the gasket layers that are used, if present, may extend to varying degrees through the interfaces between the first frames and the separator plate and the second frames and the separator plate.

In some cases, one or both gasket layers may be omitted, e.g., in favor of the use of O-ring seals or similar compressible seal elements.

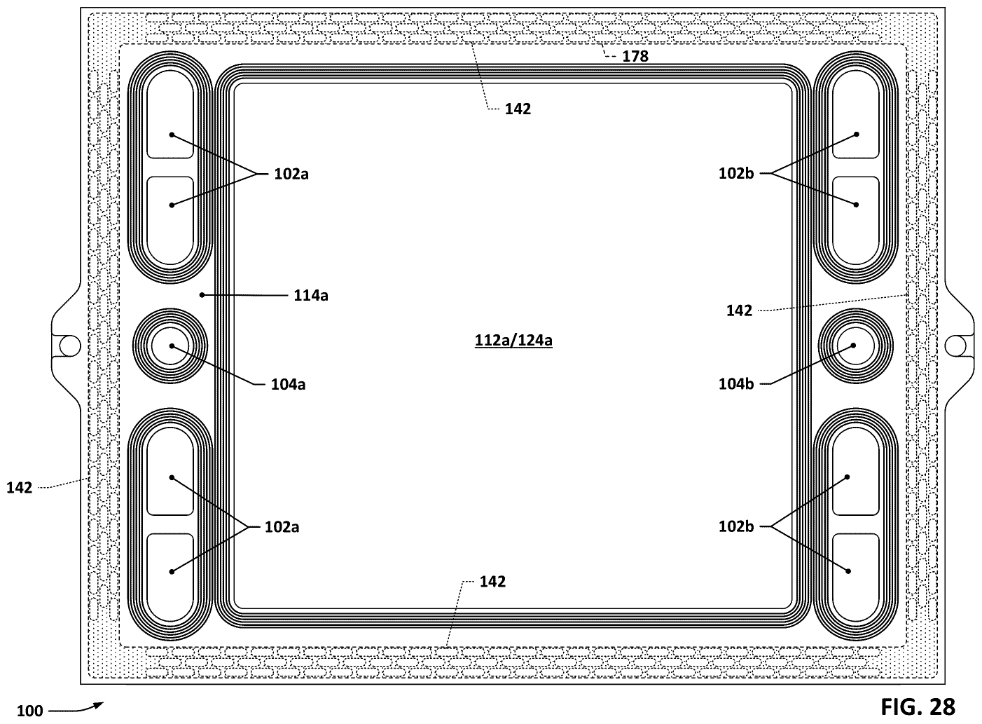

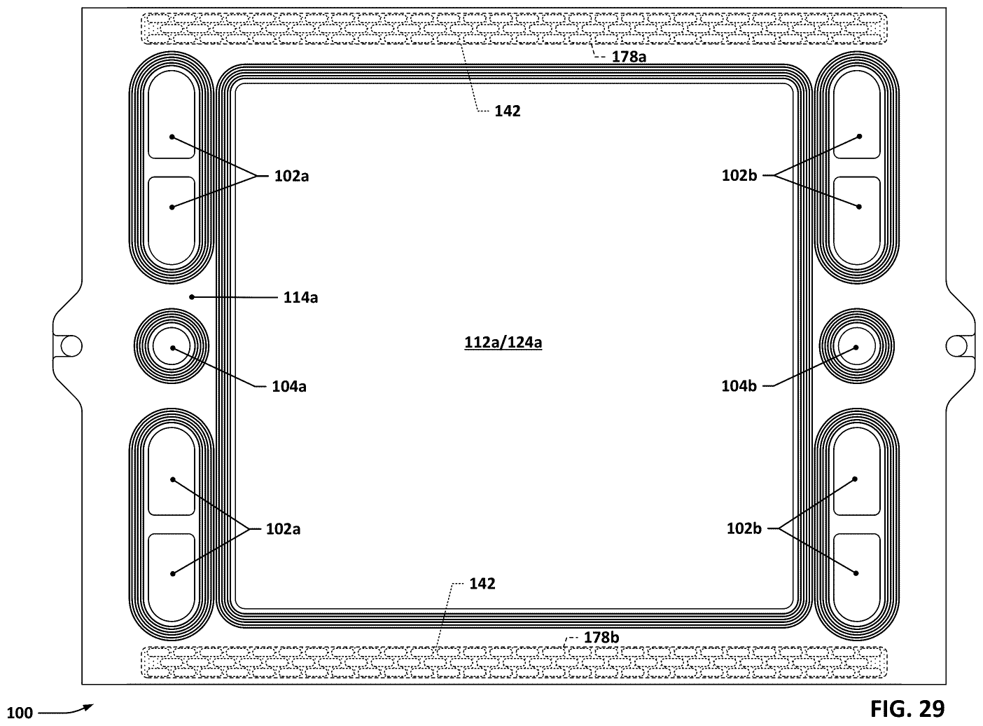

As discussed earlier with respect to FIGS. 3 and 4, the various types of first raised features discussed above (regardless of which example) may be distributed in one or more zones of a separator plate. For example, as shown in FIG. 28, a plurality of obround domed embossed features 142 may be distributed throughout a region 178 such that the obround domed embossed features 142 extend around substantially all of the first flow field region 112a. The domed embossed features 142 of FIG. 28 are shown in dotted outline since they would, in the configuration shown, not be visible due to at least the presence of the first frame 114a. Alternatively, as shown in FIG. 29, which is similar to FIG. 28, a plurality of obround domed embossed features 142 may be distributed throughout two discrete regions 178a and 178b that bracket the first flow field region 112a such that the obround domed embossed features 142 extend only partially around the first flow field region 112a.

For the purposes of this disclosure, “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. As used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.” Further, the use, if any, of ordinal indicators, such as (a), (b), (c), . . . , or (1), (2), (3), . . . , or the like, in this disclosure and accompanying claims, is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated), unless indicated otherwise. For example, if step (ii) involves the handling of an element that is created in step (i), then step (ii) may be viewed as happening at some point after step (i). In a similar manner, if step (i) involves the handling of an element that is created in step (ii), the reverse is to be understood.

The term “between,” as used herein and when used with a range of values, is to be understood, unless otherwise indicated, as being inclusive of the start and end values of that range. For example, between 1 and 5 is to be understood as inclusive of the numbers 1, 2, 3, 4, and 5, not just the numbers 2, 3, and 4.

As used herein, the singular forms, “a,” “an,” and “the” are intended to include the plural forms as well, unless the context clearly indicates otherwise. It is also to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). Moreover, a subset may include all of the members of a set. In addition, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered as illustrative and not as restrictive, and embodiments are not to be limited to the details given herein. To this end, it should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure. However, the disclosure, at a minimum, includes the following numbered list of implementations (although this numbered list of implementations is to be understood to be non-limiting in nature; additional implementations apparent from the above discussion are also within the scope of this disclosure).

Implementation 1: A cell frame assembly for an electrochemical cell, the cell frame assembly including:
a separator plate having a first side and a second side, the first side of the separator plate facing in an opposite direction from the second side of the separator plate; and
a first frame having a first side, a second side, an inner perimeter, and an outer perimeter, wherein:
   the first side of the first frame faces towards the first side of the separator plate and the second side of the first frame faces in an opposite direction from the first side of the first frame,
   the inner perimeter of the first frame defines a first flow field aperture that defines a first flow field region on the first side of the separator plate,
   the separator plate is positioned adjacent to the first frame and spans across the first flow field aperture,
   the first side of the separator plate includes one or more first raised features,
   each first raised feature has a corresponding first surface that is closer to the second side of the first frame than a corresponding portion of the first side of the separator plate adjacent to that first raised feature and outside of the first flow field region,
   the first side of the first frame includes one or more first receiving features,
   each first receiving feature is sized to receive at least one of the one or more first raised features, and
   each first receiving feature is configured to constrain translation of the first frame relative to the separator plate in at least one direction transverse to the cell frame assembly when the at least one of the one or more first raised features extends into that first receiving feature.

Implementation 2: The cell frame assembly of implementation 1, wherein each first raised feature is a portion of the separator plate having an increased thickness relative to other portions of the separator plate.

Implementation 3: The cell frame assembly of implementation 2, wherein the separator plate is a single, unitary piece.

Implementation 4: The cell frame assembly of implementation 2, wherein the separator plate comprises a sheet of material and each first raised feature is provided by a first wall element that is affixed to the sheet of material.

Implementation 5: The cell frame assembly of implementation 4, wherein the sheet of material and the one or more first wall elements are made of metal and the one or more first wall elements are welded, soldered, or brazed to the sheet of material.

Implementation 6: The cell frame assembly of implementation 4, wherein the sheet of material and the one or more first wall elements are made of metal, and the one or more first wall elements are deposited on the sheet of material via additive manufacturing.

Implementation 7: The cell frame assembly of implementation 2, further comprising a second frame having a first side, a second side, an inner perimeter, and an outer perimeter, wherein:
the first side of the second frame faces towards the second side of the separator plate and the second side of the second frame faces in an opposite direction from the first side of the second frame,
the inner perimeter of the second frame defines a second flow field aperture that defines a second flow field region on the second side of the separator plate,
the separator plate is interposed between the first frame and the second frame and spans across the second flow field aperture,
the second side of the separator plate includes one or more second raised features,
each second raised feature has a corresponding second surface that is closer to the second side of the second frame than a corresponding portion of the second side of the separator plate adjacent to that second raised feature and outside of the second flow field region,
the first side of the second frame includes one or more second receiving features,
each second receiving feature is sized to receive at least one of the one or more second raised features,
each second receiving feature is configured to constrain translation of the second frame relative to the separator plate in at least one direction transverse to the cell frame assembly when the at least one of the one or more second raised features extends into that second receiving feature, and
each second raised feature is a portion of the separator plate having an increased thickness relative to other portions of the separator plate.

Implementation 8: The cell frame assembly of implementation 7, wherein the separator plate is a single, unitary piece.

Implementation 9: The cell frame assembly of implementation 7, wherein:
the separator plate comprises a sheet of material,
each first raised feature is provided by a first wall element that is affixed to a first side of the sheet of material, and
each second raised feature is provided by a second wall element that is affixed to a second side of the sheet of material opposite the first side of the sheet of material.

Implementation 10: The cell frame assembly of implementation 9, wherein
the sheet of material, the one or more first wall elements, and the one or more second wall elements are made of metal,
the one or more first wall elements are welded, soldered, or brazed to the sheet of material, and
the one or more second wall elements are welded, soldered, or brazed to the sheet of material.

Implementation 11: The cell frame assembly of implementation 9, wherein
the sheet of material, the one or more first wall elements, and the one or more second wall elements are made of metal,
the one or more first wall elements are deposited on the sheet of material via additive manufacturing, and
the one or more second wall elements are deposited on the sheet of material via additive manufacturing.

Implementation 12: The cell frame assembly of any one of implementations 7 through 11, wherein:
each first raised feature is located in a corresponding first location on the first side of the separator plate,
each second raised feature is located in a corresponding second location on the second side of the separator plate, and
each first location corresponds in location to one of the second locations.

Implementation 13: The cell frame assembly of any one of implementations 7 through 11, wherein the separator plate is symmetric about a plane midway between the second sides of the first frame and the second frame.

Implementation 14: The cell frame assembly of implementation 1, wherein:
the separator plate further comprises one or more first recessed features,
each first recessed feature corresponds in location to one of the first raised features, and
the cell frame assembly further comprises a second frame having a first side, a second side, an inner perimeter, and an outer perimeter, wherein:
   the first side of the second frame faces towards the second side of the separator plate and the second side of the second frame faces in an opposite direction from the first side of the second frame,
   the inner perimeter of the second frame defines a second flow field aperture that defines a second flow field region on the second side of the separator plate, and
   the separator plate is interposed between the first frame and the second frame and spans across the second flow field aperture.

Implementation 15: The cell frame assembly of implementation 14, wherein the separator plate is made of sheet metal and the correspondence in location between each first raised feature and one of the first recessed features is provided by a corresponding embossed feature in the sheet metal.

Implementation 16: The cell frame assembly of implementation 15, wherein:
at least some of the embossed features are domed embossed features,
each domed embossed feature provides a corresponding convex domed surface that serves as one of the one or more first raised features and a corresponding concave domed surface that serves as one of the one or more first recessed features, and
each first recessed feature that receives the convex domed surface of one of the domed embossed features has a corresponding concave domed surface.

Implementation 17: The cell frame assembly of implementation 16, wherein the corresponding convex domed surface of each domed embossed feature mates against the corresponding concave domed surface of the first receiving feature that receives that domed embossed feature.

Implementation 18: The cell frame assembly of any one of implementations 14 through 17, wherein:
the first side of the second frame includes one or more second raised features, and
each second raised feature is sized to be insertable into a corresponding one of the first recessed features and configured to constrain translation of the second frame relative to the separator plate in at least one direction transverse to the cell frame assembly when that second raised feature of the one or more second raised features extends into that second receiving feature.

Implementation 19: The cell frame assembly of implementation 16, wherein:
the first side of the second frame includes one or more second raised features,
each second raised feature is sized to be insertable into a corresponding one of the domed embossed features and configured to constrain translation of the second frame relative to the separator plate in at least one direction transverse to the cell frame assembly when that second raised feature of the one or more second raised features extends into that second receiving feature, and
each second raised feature inserted into the concave domed surface of one of the domed embossed features has a corresponding convex domed surface.

Implementation 20: The cell frame assembly of implementation 19, wherein:
the corresponding convex domed surface of each domed embossed feature mates against the corresponding concave domed surface of the first receiving feature that receives that domed embossed feature, and
the corresponding concave domed surface of each domed embossed feature mates against the corresponding convex domed surface of the second raised feature that is inserted into that domed embossed feature.

Implementation 21: The cell frame assembly of any one of implementations 16, 17, 19, or 20, wherein:
a first subset of the domed embossed features is positioned a first distance away from the first flow field region,
a second subset of the domed embossed features is positioned a second distance away from the first flow field region, and
the second distance is greater than the first distance.

Implementation 22: The cell frame assembly of any one of implementations 16, 17, 19, 20, or 21, wherein the domed embossed features are arranged along a zig-zag path.

Implementation 23: The cell frame assembly of any one of implementations 16, 17, 19, 20, 21 or 22, wherein at least some of the domed embossed features are in the form of spherical domes.

Implementation 24: The cell frame assembly of any one of implementations 16, 17, 19, 20, 21 or 22, wherein at least some of the domed embossed features are in the form of obround domes.

Implementation 25: The cell frame assembly of any one of implementations 1 through 22, wherein:
the first frame comprises a first receiving frame and one or more first frame inserts,
each first frame insert is positioned within a corresponding first recess in the first receiving frame, and
the first receiving features are distributed across the one or more first frame inserts.

Implementation 26: The cell frame assembly of implementation 25, wherein the first frame has only a single first frame insert and the first frame insert extends around the first flow field aperture.

Implementation 27: The cell frame assembly of any one of implementations 7 through 22, wherein:
the first frame comprises a first receiving frame and one or more first frame inserts,
the second frame comprises a second receiving frame and one or more second frame inserts,
each first frame insert is positioned within a corresponding first recess in the first receiving frame,
each second frame insert is positioned within a corresponding second recess in the second receiving frame,
the first receiving features are distributed across the one or more first frame inserts, and
the second receiving features are distributed across the one or more second frame inserts.

Implementation 28: The cell frame assembly of implementation 27, wherein:
the first frame has only a single first frame insert and the first frame insert extends around the first flow field aperture, and
the second frame has only a single second frame insert and the second frame insert extends around the second flow field aperture.

Implementation 29: The cell frame assembly of implementation 28, wherein the first receiving frame and the second receiving frame are identical.

Implementation 30: The cell frame assembly of any one of implementations 1 through 29, further comprising a first gasket layer interposed between the first side of the separator plate and the first side of the first frame, the first gasket layer having an inner perimeter that defines a first aperture that extends through the first gasket layer.

Implementation 31: The cell frame assembly of implementation 30, wherein:
the first side of the first frame includes one or more first ridge features located within a first clamping region of the first side of the first frame that overlaps with the first gasket layer when viewed along an axis that is perpendicular to the second side of the first frame, and
each first ridge feature protrudes into the first gasket layer when the first frame and the separator plate are caused to compress the portion of the first gasket layer located within the first clamping region.

Implementation 32: The cell frame assembly of implementation 31, wherein each first ridge feature extends entirely around the first aperture.

Implementation 33: The cell frame assembly of implementation 32, wherein the one or more first ridge features is a plurality of concentrically arranged first ridge features.

Implementation 34: The cell frame assembly of any one of implementations 31 through 33, wherein the first aperture in the first gasket layer is the same size and shape as the first flow field aperture in the first frame.

Implementation 35: The cell frame assembly of any one of implementations 7 through 29, further comprising:
a first gasket layer interposed between the first side of the separator plate and the first side of the first frame, the first gasket layer having an inner perimeter that defines a first aperture that extends through the first gasket layer, and
a second gasket layer interposed between the first side of the separator plate and the first side of the second frame, the second gasket layer having an inner perimeter that defines a second aperture that extends through the second gasket layer.

Implementation 36: The cell frame assembly of implementation 35, wherein:
the first side of the first frame includes one or more first ridge features located within a first clamping region of the first side of the first frame that overlaps with the first gasket layer when viewed along an axis that is perpendicular to the second side of the first frame,
each first ridge feature protrudes into the first gasket layer when the first frame and the separator plate are caused to compress the portion of the first gasket layer located within the first clamping region,
the first side of the second frame includes one or more second ridge features located within a second clamping region of the first side of the second frame that overlaps with the second gasket layer when viewed along an axis that is perpendicular to the second side of the first frame, and
each second ridge feature protrudes into the second gasket layer when the second frame and the separator plate are caused to compress the portion of the second gasket layer located within the second clamping region.

Implementation 37: The cell frame assembly of implementation 31, wherein:
each first ridge feature extends entirely around the first aperture, and
each second ridge feature extends entirely around the second aperture.

Implementation 38: The cell frame assembly of implementation 37, wherein:
the one or more first ridge features is a plurality of concentrically arranged first ridge features, and
the one or more second ridge features is a plurality of concentrically arranged second ridge features.

Implementation 39: The cell frame assembly of any one of implementations 35 through 38, wherein:
the first aperture in the first gasket layer is the same size and shape as the first flow field aperture in the first frame, and
the second aperture in the second gasket layer is the same size and shape as the second flow field aperture in the second frame.

Implementation 40: The cell frame assembly of any one of implementations 35 through 39, wherein:
the first gasket layer is made of a material comprising polytetrafluoroethylene, and
the second gasket layer is made of a material comprising polytetrafluoroethylene.

Implementation 41: The cell frame assembly of any one of implementations 30 through 39, wherein the first gasket layer is made of a material comprising polytetrafluoroethylene.

Implementation 42: The cell frame assembly of any one of implementations 1 through 41, wherein the one or more first raised features include at least two first raised features that are positioned such that the first flow field aperture is interposed between the at least two first raised features.

Implementation 43: The cell frame assembly of any one of implementations 1 through 41, wherein the one or more first raised features include at least one first wall element that extends entirely around the first flow field aperture.

Implementation 44: The cell frame assembly of any one of implementations 43, wherein there is only one first raised feature and the first raised feature extends entirely around the first flow field aperture.

Implementation 45: The cell frame assembly of any one of implementations 1 through 41, wherein the one or more first raised features includes a plurality of first raised features distributed throughout a region that encircles the first flow field region.

Implementation 46: The cell frame assembly of any one of implementations 1 through 41, wherein the one or more first raised features includes a plurality of first raised features distributed throughout a first region on one side of the first flow field region and a second region on an opposite side of the first flow field region.

Implementation 47: The cell frame assembly of any one of implementations 1 through 46, wherein the separator plate is made of metal.

Implementation 48: The cell frame assembly of implementation 47, wherein the separator plate is made of a titanium-containing metal.

Implementation 49: The cell frame assembly of any one of implementations 1 through 48, wherein the first frame is made of a polymeric material.

What is claimed is:

1. A cell frame assembly for an electrochemical cell, the cell frame assembly including:
a separator plate having a first side and a second side, the first side of the separator plate facing in an opposite direction from the second side of the separator plate; and
a first frame having a first side, a second side, an inner perimeter, and an outer perimeter, wherein:
the first side of the first frame faces towards the first side of the separator plate and the second side of the first frame faces in an opposite direction from the first side of the first frame,
the inner perimeter of the first frame defines a first flow field aperture that defines a first flow field region on the first side of the separator plate,
the separator plate is positioned adjacent to the first frame and spans across the first flow field aperture,
the first side of the separator plate includes one or more first raised features,
each first raised feature has a corresponding first surface that is closer to the second side of the first frame than a corresponding portion of the first side of the separator plate adjacent to that first raised feature and outside of the first flow field region,
the first side of the first frame includes one or more first receiving features,
each first receiving feature is sized to receive at least one of the one or more first raised features, and
each first receiving feature is configured to constrain translation of the first frame relative to the separator plate in at least one direction transverse to the cell frame assembly when the at least one of the one or more first raised features extends into that first receiving feature.

2. The cell frame assembly of claim 1, wherein each first raised feature is a portion of the separator plate having an increased thickness relative to other portions of the separator plate.

3. The cell frame assembly of claim 2, wherein the separator plate is a single, unitary piece.

4. The cell frame assembly of claim 2, wherein the separator plate comprises a sheet of material and each first raised feature is provided by a first wall element that is affixed to the sheet of material.

5. The cell frame assembly of claim 2, further comprising a second frame having a first side, a second side, an inner perimeter, and an outer perimeter, wherein:
the first side of the second frame faces towards the second side of the separator plate and the second side of the second frame faces in an opposite direction from the first side of the second frame,
the inner perimeter of the second frame defines a second flow field aperture that defines a second flow field region on the second side of the separator plate,
the separator plate is interposed between the first frame and the second frame and spans across the second flow field aperture,
the second side of the separator plate includes one or more second raised features,
each second raised feature has a corresponding second surface that is closer to the second side of the second frame than a corresponding portion of the second side of the separator plate adjacent to that second raised feature and outside of the second flow field region,
the first side of the second frame includes one or more second receiving features,
each second receiving feature is sized to receive at least one of the one or more second raised features,
each second receiving feature is configured to constrain translation of the second frame relative to the separator plate in at least one direction transverse to the cell frame assembly when the at least one of the one or more second raised features extends into that second receiving feature, and
each second raised feature is a portion of the separator plate having an increased thickness relative to other portions of the separator plate.

6. The cell frame assembly of claim 5, wherein the separator plate is a single, unitary piece.

7. The cell frame assembly of claim 5, wherein:
the separator plate comprises a sheet of material,
each first raised feature is provided by a first wall element that is affixed to a first side of the sheet of material, and
each second raised feature is provided by a second wall element that is affixed to a second side of the sheet of material opposite the first side of the sheet of material.

8. The cell frame assembly of claim 1, wherein:
the separator plate further comprises one or more first recessed features,
each first recessed feature corresponds in location to one of the first raised features, and
the cell frame assembly further comprises a second frame having a first side, a second side, an inner perimeter, and an outer perimeter, wherein:
the first side of the second frame faces towards the second side of the separator plate and the second side of the second frame faces in an opposite direction from the first side of the second frame,
the inner perimeter of the second frame defines a second flow field aperture that defines a second flow field region on the second side of the separator plate, and
the separator plate is interposed between the first frame and the second frame and spans across the second flow field aperture.

9. The cell frame assembly of claim 8, wherein:
the first side of the second frame includes one or more second raised features, and
each second raised feature is sized to be insertable into a corresponding one of the first recessed features and configured to constrain translation of the second frame relative to the separator plate in at least one direction transverse to the cell frame assembly when that second raised feature of the one or more second raised features extends into that second receiving feature.

10. The cell frame assembly of claim 1, wherein:
the first frame comprises a first receiving frame and one or more first frame inserts,
each first frame insert is positioned within a corresponding first recess in the first receiving frame, and
the first receiving features are distributed across the one or more first frame inserts.

11. The cell frame assembly of claim 10, wherein the first frame has only a single first frame insert and the first frame insert extends around the first flow field aperture.

12. The cell frame assembly of claim 5, wherein:
the first frame comprises a first receiving frame and one or more first frame inserts,
the second frame comprises a second receiving frame and one or more second frame inserts,
each first frame insert is positioned within a corresponding first recess in the first receiving frame,
each second frame insert is positioned within a corresponding second recess in the second receiving frame,
the first receiving features are distributed across the one or more first frame inserts, and
the second receiving features are distributed across the one or more second frame inserts.

13. The cell frame assembly of claim 12, wherein:
the first frame has only a single first frame insert and the first frame insert extends around the first flow field aperture, and
the second frame has only a single second frame insert and the second frame insert extends around the second flow field aperture.

14. The cell frame assembly of claim 1, further comprising a first gasket layer interposed between the first side of the separator plate and the first side of the first frame, the first gasket layer having an inner perimeter that defines a first aperture that extends through the first gasket layer.

15. The cell frame assembly of claim 14, wherein:
the first side of the first frame includes one or more first ridge features located within a first clamping region of the first side of the first frame that overlaps with the first gasket layer when viewed along an axis that is perpendicular to the second side of the first frame, and
each first ridge feature protrudes into the first gasket layer when the first frame and the separator plate are caused to compress the portion of the first gasket layer located within the first clamping region.

16. The cell frame assembly of claim 15, wherein the first aperture in the first gasket layer is the same size and shape as the first flow field aperture in the first frame.

17. The cell frame assembly of claim 1, wherein the one or more first raised features include at least two first raised features that are positioned such that the first flow field aperture is interposed between the at least two first raised features.

18. The cell frame assembly of claim 1, wherein the one or more first raised features include at least one first wall element that extends entirely around the first flow field aperture.

19. The cell frame assembly of claim 1, wherein the one or more first raised features includes a plurality of first raised features distributed throughout a region that encircles the first flow field region.

20. The cell frame assembly of claim 1, wherein the one or more first raised features includes a plurality of first raised features distributed throughout a first region on one side of the first flow field region and a second region on an opposite side of the first flow field region.

21. The cell frame assembly of claim 1, wherein the separator plate is made of metal.

22. The cell frame assembly of claim 21, wherein the separator plate is made of a titanium-containing metal.

23. The cell frame assembly of claim 1, wherein the first frame is made of a polymeric material.
